(19) United States
(12) Patent Application Publication
(10) Pub. No.: US 2014/0122661 A1
(43) Pub. Date: May 1, 2014

(54) COMPUTER SYSTEM AND FILE SERVER MIGRATION METHOD

(71) Applicant: Hitachi, Ltd., Tokyo (JP)

(72) Inventors: Masanori Takata, Yokohama-shi (JP); Hitoshi Kamei, Sagamihara-shi (JP); Jun Nemoto, Tokyo (JP); Takayuki Fukutani, Yokohama-shi (JP); Atsushi Sutoh, Yokohama-shi (JP)

(73) Assignee: Hitachi, Ltd., Tokyo (JP)

(21) Appl. No.: 13/696,442

(22) PCT Filed: Oct. 26, 2012
(86) PCT No.: PCT/JP12/06895

§ 371 Date: May 14, 2013

(51) Int. Cl. H04L 29/08

(52) U.S. Cl. CPC H04L 67/1097
USPC 709/219

(57) ABSTRACT

A file server is replaced efficiently. A computer system includes a first file server, a second file server, and a third file server. The first file server retains file data storage information which indicates, for each file, whether data of the relevant file is stored in a first storage device or not; and after a data input/output request from a client terminal is switched from the first file server to the third file server, the third file server selects either the first file server or the second file server as a data transfer request destination of a target file of the data input/output request from the client terminal, based on the file data storage information sent from the first file server.

### TECHNICAL FIELD

The present invention relates to a computer system and a file server migration method and is suited for use in a computer system and file server migration method for transferring data efficiently at the time of migration of a file server connected to an archive device for storing data for a long period of time.

### BACKGROUND ART

Recently, an amount of digital data, particularly an amount of file data has been increasing at a rapid pace. A file server represented by, for example, NAS (Network Attached Storage) is a storage apparatus for providing users with smooth file services by allowing many computers to share file data via a network.

The digital data including the file data needs to be stored for a long period of time in accordance with requirements of various laws and regulations. An archive device represented by CAS (Content Addressed Storage) provides a system for archiving data for a long period of time. Generally, while data is being used, the data is stored in the NAS and is then migrated to the CAS. For example, for compliance with the laws and regulations, data stored in the NAS is stored in the archive device for the archival purpose or data which has not been accessed for a certain period of time is migrated to the CAS to secure the capacity of the file server. Also, data stored in the NAS can be copied to the CAS for the purpose of backing up the data.

For example, there is a system in which a CAS device is located at a data center, a NAS device is located at each base such as each department of a company, the CAS device and the NAS devices are connected via a communication network such as a WAN (Wide Area Network), and data in the distributed NAS devices are intensively managed in the CAS device. Data in the NAS devices is archived to the CAS device at specified timing.

If file data accessed from the client terminal is not stored in the NAS device, the NAS device needs to recall the file data from the CAS device. On the other hand, if a file accessed from the client is stored in the NAS, that is, if the NAS device has cached the file, the NAS device does not have to recall the file data from the CAS device.

Meanwhile, it is sometimes necessary to replace the NAS device once several years because of reasons such as performance deficiency, capacity shortage, or expiration of a maintenance term; and when replacing (or migrating) the NAS device, its data needs to be copied to a new NAS device. Possible data copying methods include a method of copying data from the CAS device to the new NAS device and a method of copying data from the old NAS device to the new NAS device. The former method requires the acquisition of all pieces of data from the CAS device via the WAN, thereby causing a problem of an increase of the network traffic. On the other hand, the latter method requires the acquisition of data, which is not stored in the old NAS device, from the CAS device and copying of the data from the old NAS device to the new NAS device. Therefore, in this case, there is also the problem of an increase of the network traffic.

PTL 1 discloses that the increase of the network traffic can be prevented by performing remote copying of a stub, which is stored in the NAS device, as it is without recalling it, and updating stub information stored in the NAS device at a remote site after the data of the CAS is copied to the remote site (the new NAS device). The stub herein used means metadata indicating a storage location of actual data and recalling the stub means acquisition of data from the storage location of the actual data as indicated by the stub.

### CITATION LIST

### Patent Literature

[PTL 1]
US 2009/030079

### SUMMARY OF INVENTION

### Technical Problem

However, the above-described PTL 1 needs to obtain data, which has been accessed by a client terminal, from the CAS device, so that the cache data stored in the old NAS device cannot be used when replacing the NAS device and the network traffic thereby increases, causing the problem of response performance degradation.

The present invention was devised in consideration of the above-described circumstances and aims at suggesting a computer system and file server migration method capable of efficient file server replacement by migrating data by using cache data of a file server.

### Solution to Problem

In order to solve the above-described problem, provided according to the present invention is a computer system including: a first file server for receiving a data input/output request from a client terminal and storing data of a target file of the data input/output request in a first storage device; a second file server for storing data of a file, which is stored in the first storage device and sent from the first file server, in a second storage device; and a third file server, which is a migration destination of the first file server, for storing the data of the target file of the data input/output request in a third storage device; wherein the first file server retains, for each file, file data storage information indicating whether data of the relevant file is stored in the first storage device or not; and wherein after the data input/output request from the client terminal is switched from the first file server to the third file server, the third file server selects either the first file server or the second file server as a data transfer request destination of the target file of the data input/output request from the client terminal, based on the file data storage information sent from the first file server.

If the above-described configuration is employed and data which has been written to the storage device of the first file server is stored in the storage device of the second file server, the third file server which is the migration destination at the time of migration of the first file server decides whether the first file server or the second file server should be the transfer request destination of the data, based on the file data storage information which indicates whether or not the data of the file is stored in the first storage device. As a result, the file server can be replaced efficiently by migrating the data by using the cache data of the file server; and the response performance can be enhanced by reducing the network traffic when replacing the file server.

### Advantageous Effects of Invention

The response performance can be enhanced by reducing the network traffic when replacing the file server according to the present invention.

### BRIEF DESCRIPTION OF DRAWINGS

FIG. 1 is a block diagram showing a hardware configuration of a computer system according to a first embodiment of the present invention.

FIG. 2 is a block diagram showing the configuration of a file server according to the embodiment.

FIG. 3 is a chart showing an example of directory configuration information according to the embodiment.

FIG. 4 is a block diagram showing the configuration of an archive device according to the embodiment.

FIG. 5 is an explanatory diagram for explaining the outline of data migration processing according to the embodiment.

FIG. 6 is an explanatory diagram for explaining the outline of the data migration processing according to the embodiment.

FIG. 7 is a flowchart illustrating file sharing service migration processing according to the embodiment.

FIG. 8 is a flowchart illustrating file server migration processing according to the embodiment.

FIG. 9 is a flowchart illustrating directory migration processing according to the embodiment.

FIG. 10 is a flowchart illustrating file migration processing according to the embodiment.

FIG. 11 is a flowchart illustrating data copy processing according to the embodiment.

FIG. 12 is a flowchart illustrating data deletion processing according to the embodiment.

FIG. 13 is a block diagram showing a hardware configuration of a computer system according to a second embodiment of the present invention.

FIG. 14 is a block diagram showing a file server according to the embodiment.

FIG. 15 is a chart showing an example of an update file list according to the embodiment.

FIG. 16 is a chart showing an example of the update file list according to the embodiment.

FIG. 17 is a block diagram showing the configuration of an archive device according to the embodiment.

FIG. 18 is a chart showing an example of a base-based update file list according to the embodiment.

FIG. 19 is an explanatory diagram for explaining the outline of data migration processing according to the embodiment.

FIG. 20 is an explanatory diagram for explaining the outline of the data migration processing according to the embodiment.

FIG. 21 is a flowchart illustrating processing for creating the base-based update file list according to the embodiment.

FIG. 22 is a flowchart illustrating file migration processing according to the embodiment.

FIG. 23 is a chart showing directory configuration information according to a third embodiment of the present invention.

FIG. 24 is an explanatory diagram for explaining the outline of data migration processing according to the embodiment.

FIG. 25 is a flowchart illustrating directory migration processing according to the embodiment.

### DESCRIPTION OF EMBODIMENTS

An embodiment of the present invention will be explained with reference to the attached drawings.

### (1) First Embodiment

(1-1) Outline of this Embodiment

This embodiment is applied to data migration processing when replacing an old file server with a new file server because of reasons such as performance deficiency, capacity shortage, or expiration of a maintenance term of a file server, in a configuration where the file server and another file server for archiving data of the former file server (this file server will be hereinafter sometimes referred to as the archive device) are connected via a network such as a WAN. Particularly, the data migration processing from the old file server to the new file server is applied to on-demand restoration processing for migrating file data of a target file to the new file server when a user accesses the file.

In the conventional on-demand restoration processing, data to be migrated to the new file server is obtained from the archive device. However, since the archive device and the file server are connected via a network with low transfer performance such as a WAN, the network traffic increases. Also, it is possible to migrate file data directly from the old file server to the new file server. However, since some of the file data have already been deleted from the old file server, not all pieces of the file data can be obtained from the old file server. In this case, the data will be migrated from the archive device to the old file server and will be then transferred from the old file server to the new file server, so that the increase of the network traffic cannot be avoided.

So, in this embodiment, the location where the file data is to be obtained is changed depending on whether the file data requested by the client terminal is stored in the old file server or not. Specifically speaking, file data storage information which indicates whether the file data is stored in the old file server or not is reported to the new file server. Then, if the relevant file data is stored in the old file server when obtaining the file data upon a request from the client terminal, the data is obtained from the old file server; and if the file data is not stored in the old file server, the data is migrated from the archive device. In this way, response performance can be enhanced by reducing the network traffic by using cache data stored in the old file server.

### (1-2) Configuration of Computer System

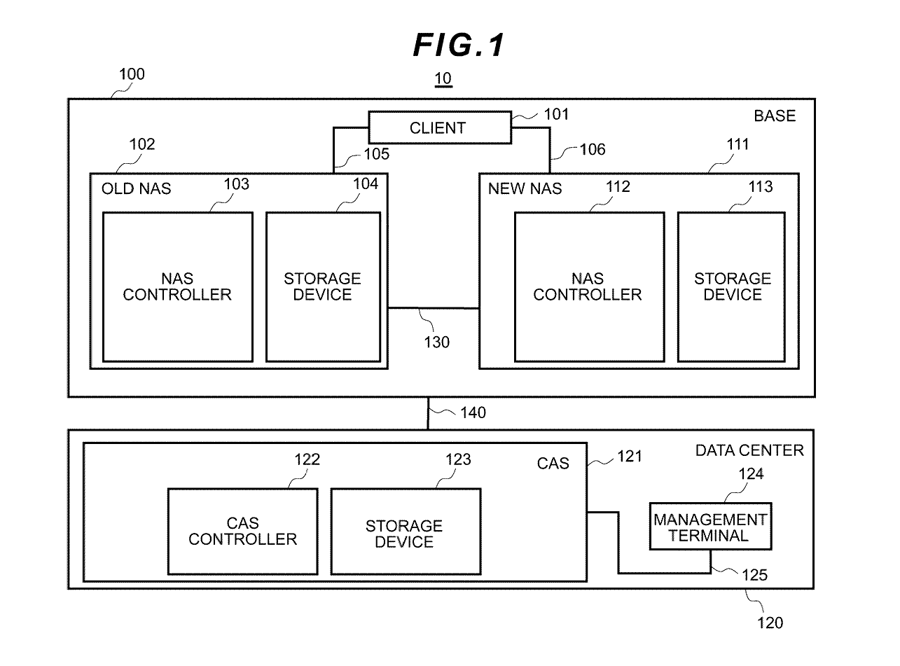

Next, the hardware configuration and software configuration of a computer system according to this embodiment will be explained. As shown in FIG. 1, a computer system 10 includes a base 100 and a data center 120; and the base 100 and the data center 120 are connected via a WAN 140.

The base 100 includes a file server 102 and a client 101. An example of the file server 102 can be a NAS device that shares file data via the network. In the following explanation, a NAS device will be applied and explained as the file server 102. At the base 100, an old NAS 102 before replacement and a new NAS 111 after the replacement are connected via a LAN (Local Area Network). Also, the client 101 is connected to the old NAS 102 and the new NAS 111 via a LAN

Furthermore, the data center 120 includes an archive device 121 and a management terminal 124. An example of the archive device 121 can be a CAS device providing a system for archiving data for a long period of time. In the following explanation, a CAS device will be applied and explained as the archive device 121. At the data center 120, the CAS 121 and the management terminal 124 are connected via a network such as a LAN.

### (1-2-1) Configuration of File Server

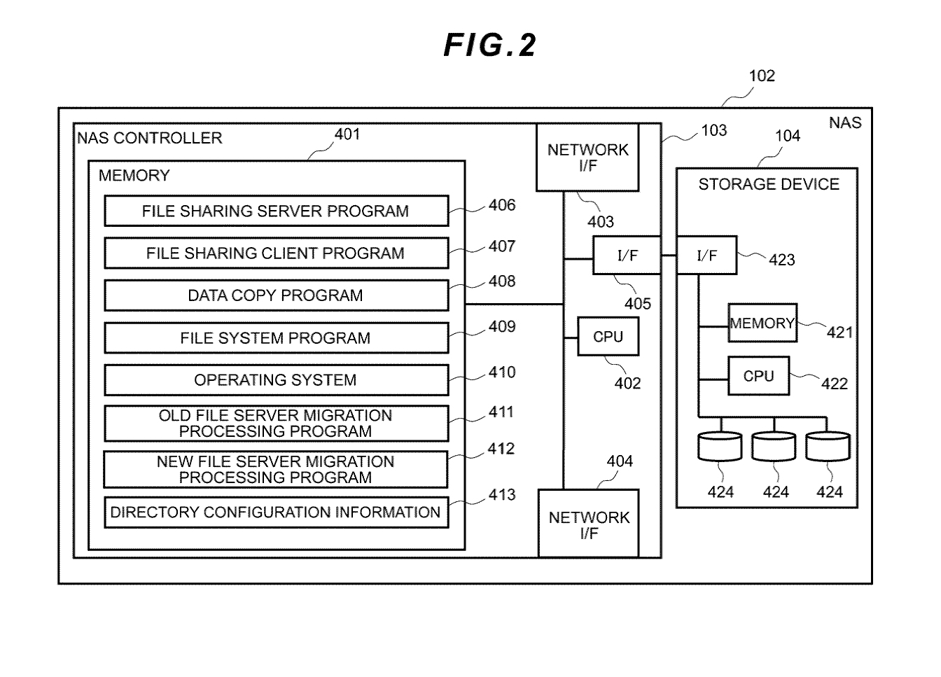

Next, the configuration of the file servers (the old NAS 102 and the new NAS 111) will be explained with reference to FIG. 2. Since the old NAS 102 and the new NAS 111 have the same hardware configuration and software configuration, the old NAS 102 will be taken as an example and explained.

As shown in FIG. 2, the old NAS 102 includes a NAS controller 103 and a storage device 104. The NAS controller 103 controls input/output of various data stored in the storage device 104.

The NAS controller 103 is mainly constituted from a memory 401, a CPU (Central Processing Unit) 402, network interfaces (indicated as Network I/F in the drawing) 403, 404, and an interface 405 (indicated as I/F in the drawing).

The CPU 402 functions as an arithmetic processing unit and controls the operation of the entire old NAS 102 in accordance with, for example, various programs and operation parameters stored in the memory 401. The network interface 403, 404 is an interface for connecting to the client 101 and the CAS 121 via the network. The interface 405 is an interface for connecting to the storage device 104 via the network.

The memory 401 mainly stores, for example, a file sharing server program 406, a file sharing client program 407, a data copy program 408, a file system program 409, an operating system 410, an old file server migration processing program 411, a new file server migration processing program 412, and directory configuration information 413.

The file sharing server program 406 is a program for controlling file sharing between the file servers. The file sharing client program 407 is a program for providing a file sharing service to the client 101. The data copy program 408 is a program for controlling data copying between the file servers. The file system program 409 is a program for managing the file system such as file generation. The operating system 410 is a program for controlling various processing within the NAS controller 103.

The old file server migration processing program 411 is a program for controlling migration processing at the old file server (the old NAS 102). The new file server migration processing program 412 is a program for controlling migration processing at the new file server (the new NAS 111). The directory configuration information 413 is a table for managing various pieces of information such as files and directories.

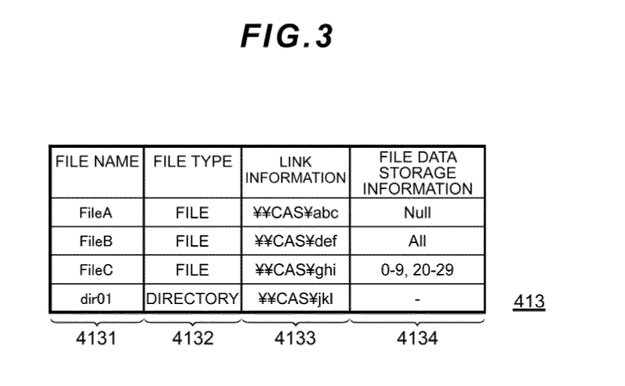

As shown in FIG. 3, the directory configuration information 413 is constituted from a file name column 4131, a file type column 4132, a link information column 4133, and a file data storage information column 4134.

The file name column 4131 stores the name of a file or directory. The file type column 4132 stores the file type such as a file or a directory. The link information column 4133 stores link information of the relevant file or directory. The file data storage information column 4134 stores information indicating whether file data is stored in the old NAS 102 or not.

Referring to FIG. 3, for example, the file type of a file name FileA is File, its link information is ¥¥CAS¥abc, and its file data storage information is Null. Accordingly, you can tell that file data of FileA is not stored in the old NAS 102. Furthermore, the file type of a file name FileB is File, its link information is ¥¥CAS¥def, and its file data storage information is All. Accordingly, you can tell that all pieces of file data of FileB are stored in the old NAS 102.

Furthermore, the file type of a file name FileC is File, its link information is ¥¥CAS¥ghi, and its file data storage information is 0-9, 20-29. Accordingly, you can tell that certain data within the address range of 0-9, 20-29 among file data of FileC is stored in the old NAS 102. Furthermore, the file type of a file name dir01 is Directory, its link information is ¥¥CAS¥jkl, and its file data storage information is -. In the case of the directory, the file data storage information column 4134 stores information indicating an invalid value.

Referring back to FIG. 2, the storage device 104 includes a memory 421, a CPU 422, an interface (indicated as I/F in the drawing) 423, and disks 424. The CPU 422 functions as an arithmetic processing unit and controls the operations of the entire storage device 104 in accordance with, for example, various programs and operation parameters stored in the memory 421. The interface 423 is an interface for connecting to the NAS controller 103 via the network.

The disks 424 are storage media for storing various data and examples of the disks 424 can include hard disk drives (HDD). The hard disk drives may be composed of, for example, a plurality of hard disk drives which are expensive hard disk drives such as SCSI (Small Computer System Interface) disks or inexpensive hard disk drives such as SATA (Serial AT Attachment) disks. Furthermore, storage media other than the hard disk drives, such as flash memories, SSDs (Solid State Drives), DVDs, optical disks, magneto-optical disks, CD-Rs, and magnetic tapes may be also used.

### (1-2-2) Configuration of Archive Device

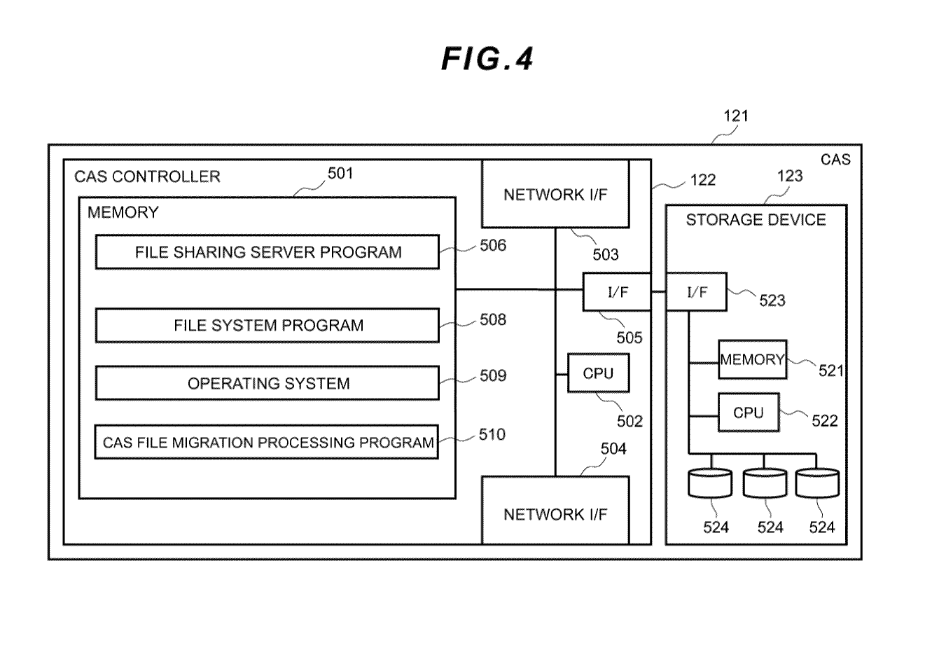

Next, the configuration of the archive device (the CAS 121) will be explained with reference to FIG. 4. As shown in FIG. 4, the CAS 121 includes a CAS controller 122 and a storage device 123. The CAS controller 122 controls input/output of various data stored in the storage device 123.

The CAS controller 122 is mainly constituted from a memory 501, a CPU 502, network interfaces (indicated as Network I/F in the drawing) 503, 504, and an interface 505 (indicated as I/F in the drawing).

The CPU 502 functions as an arithmetic processing unit and controls the operations of the entire CAS 121 in accordance with, for example, various programs and operation parameters stored in the memory 501. The network interfaces 503, 504 are interfaces for connecting to the file server (NAS) of the base 100 and the management terminal 124 via the network.

The memory 501 mainly stores a file sharing server program 506, a file system program 508, an operating system 509, and a CAS file migration processing program 510.

The file sharing server program 506 is a program for controlling file sharing between the file servers. The file system program 508 is a program for managing the file system such as file generation. The operating system 509 is a program for controlling various processing in the CAS controller 122. The CAS file migration processing program 510 is a program for controlling file migration processing in response to a file migration request of the new NAS 111.

The storage device 123 includes a memory 521, a CPU 522, an interface (indicated as I/F in the drawing) 523, and disks 524. The CPU 522 functions as an arithmetic processing unit and controls the operations of the entire storage device 123 in accordance with, for example, various programs and operation parameters stored in the memory 521. The interface 523 is an interface for connecting to the CAS controller 122 via the network.

The disks 524 are storage media for storing various data and examples of the disks 524 can include hard disk drives (HDD). The hard disk drives may be composed of, for example, a plurality of hard disk drives which are expensive hard disk drives such as SCSI (Small Computer System Interface) disks or inexpensive hard disk drives such as SATA (Serial AT Attachment) disks. Furthermore, storage media other than the hard disk drives, such as flash memories, SSDs (Solid State Drives), and DVDs may be also used.

### (1-3) Data Migration Processing in Computer System

### (1-3-1) Outline of Data Migration Processing

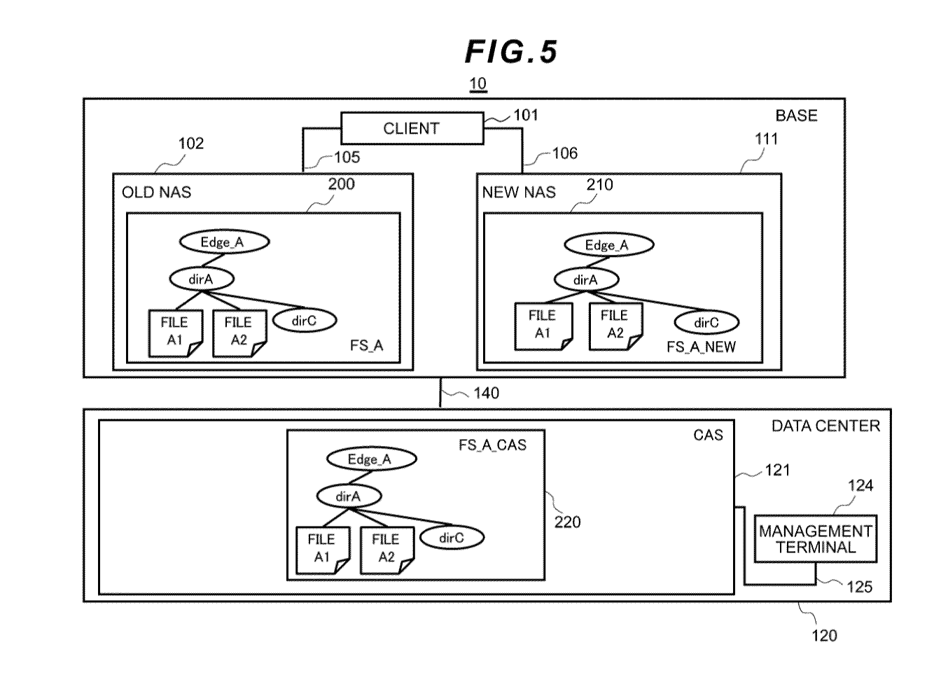

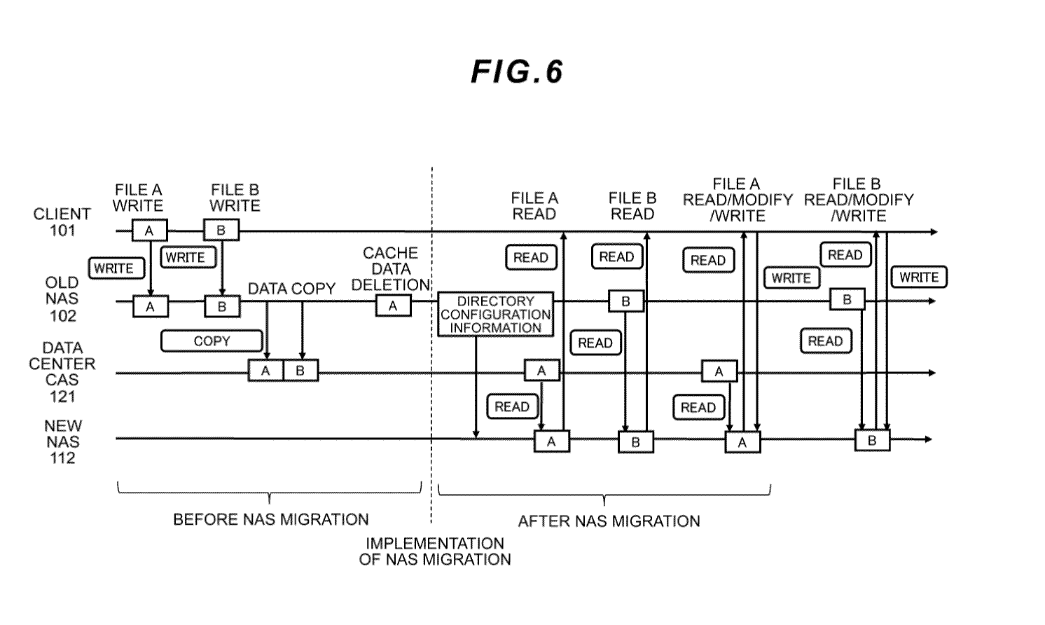

Next, the outline of data migration processing in the computer system 10 will be explained with reference to FIG. 5 and FIG. 6. As shown in FIG. 5, a file system of each file server (the old NAS 102 and the new NAS 111) stores a plurality of directories and files.

Specifically speaking, the file server (the old NAS 102 or the new NAS 111) includes a file system named FS_A or FS_A_NEW and the highest directory of FS_A or FS_A_NEW is Edge_A. Edge_A is associated with directory dirA and directory dirA is associated with file FILEA1, file FILEA2, and directory dirC. Furthermore, the CAS 121 also includes a file system FS_A_CAS and the highest directory of FS_A_CAS is Edge_A. Edge_A is associated with directory dirA and directory dirA is associated with file FILEA1, file FILEA2, and directory dirC.

Then, when data is written (WRITE) from the client 101 to file A or file B before the NAS replacement (migration) as shown in FIG. 6, file data of file A and file B is written to the old NAS 102.

Subsequently, the file data of file A and file B is copied to the CAS 121 of the data center 120. After the file data of file A and file B is copied to the CAS 121, the file data of the old NAS 102 is treated as cache data. Specifically speaking, since the file data of file A and file B is stored in the CAS 121, the file data of file A and file B, which is stored in the old NAS 102, is deleted as necessary. Then, the cache data of file A stored in the old NAS 102 is deleted.

Then, when the NAS migration processing is executed, the above-mentioned directory configuration information 413 in FIG. 3 is sent from the old NAS 102 to the new NAS 111 and file data storage information is retained for each file. Specifically speaking, the new NAS 111 creates an empty file without actual data and associates the created empty file with the file data storage information of that empty file.

After the migration processing from the old NAS 102 to the new NAS 111 is executed, the client 101 switches the access location from the old NAS 102 to the new NAS 111. Having received a request for file READ processing from the client 101, the new NAS 111 selects either the old NAS 102 or the CAS 121 as a file data acquisition location by referring to the directory configuration information 413.

Having received a request for the READ processing for reading file A or file B from the client 101, the new NAS 111 determines the acquisition location to obtain the file data of file A or file B by referring to the directory configuration information 413. Then, the new NAS 111 reads the file data of file A from the CAS 121 and reads the file data of file B from the old NAS 102.

Similarly, when the client 101 issues a request for WRITE processing for writing data to file A or file B, the new NAS 111 refers to the directory configuration information 413 and reads the file data of file A from the CAS 121 (READ), changes the file data (MODIFY), and writes the changed file A to the new NAS 111 (WRITE). Furthermore, the new NAS 111 refers to the directory configuration information 413, reads the file data of file B from the old NAS 102 (READ), changes the file data (MODIFY), and writes the changed file B to the new NAS 111 (WRITE).

During the on-demand restoration processing from the old NAS 102 to the new NAS 111, the new NAS 111 obtains the storage location information of the file requested by the client 101 and accesses either the old NAS 102, where the cache data remains, or the CAS 121 of the data center 120. In this way, the response performance can be enhanced by reducing the network traffic by effectively using the cache data of the old NAS 102 during the NAS migration.

### (1-3-2) Details of Migration Processing

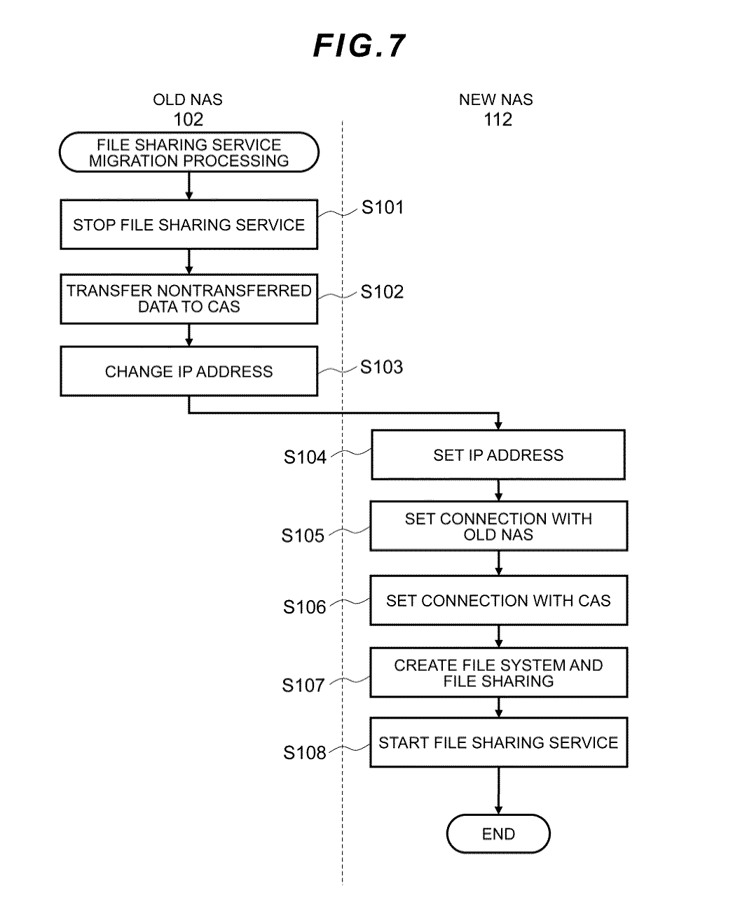

Next, the details of the migration processing from an old file server (the old NAS 102) to a new file server (the new NAS 111) will be explained with reference to FIG. 7 to FIG. 12.

Firstly, file sharing service migration processing from the old NAS 102 to the new NAS 111 will be explained with reference to FIG. 7. The file sharing service migration processing is processing for switching a file server to be accessed by the client 101. The file sharing service migration processing is executed by the file sharing server programs 406 of the old NAS 102 and the new NAS 111.

As shown in FIG. 7, the file sharing client program 407 of the old NAS 102 stops a file sharing service to the client 101 (S101). Then, the file sharing client program 407 of the old NAS 102 transfers nontransferred data to the CAS 121 of the data center (S102). The nontransferred data herein used means file data which is stored only in the old NAS 102 and has not been transferred to the CAS 121.

Then, the old NAS 102 changes its own IP address (S103). Specifically speaking, the old NAS 102 sets its own IP address to an IP address of the new NAS 111, sets another IP address to its own IP address, and notifies the new NAS 111 of the IP address.

The file sharing server program 406 of the new NAS 111 which was notified of the IP address by the old NAS 102 in step S103 sets that IP address to its own IP address (S104). Then, the file sharing server program 406 of the new NAS 111 sets a connection between the old NAS 102 and the new NAS 111 (S105) and sets a connection between the CAS 121 and the new NAS 111 (S106).

Then, the file sharing server program 406 of the new NAS 111 constructs a file system and sets file sharing settings (S107) and starts the file sharing service (S108).

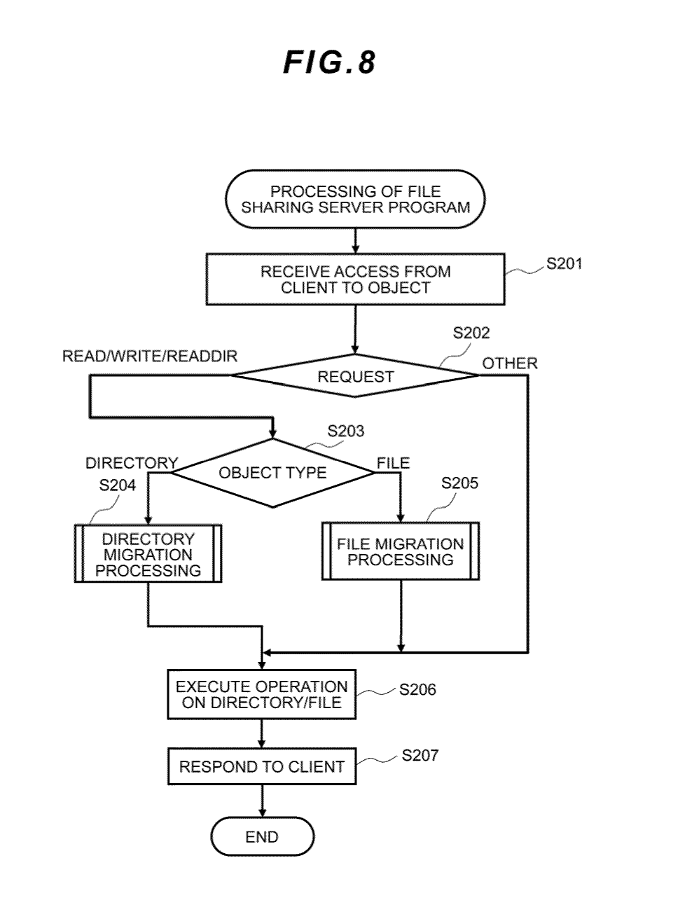

Next, the processing by the file sharing server program 406 of the new NAS 111 will be explained with reference to FIG. 8. The file sharing server program 406 executes operations on a directory or file in response to a request from the client 101 and returns the execution results to the client 101.

As shown in FIG. 8, the file sharing server program 406 of the new NAS 111 firstly receives access from the client 101 to an object (S201). The object herein used means a generic term of an operation target of the client 101 such as a directory or file.

Then, the file sharing server program 406 of the new NAS 111 judges whether the request from the client 101 is a request for file reading (READ), writing (WRITE), directory reading (READDIR), or other processing (S202).

If it is determined in step S202 that the request from the client 101 is a request for any of file reading (READ), writing (WRITE), and directory reading (READDIR), the file sharing server program 406 of the new NAS 111 executes processing in step S203 and subsequent steps. On the other hand, if it is determined in step S202 that the request from the client 101 is a request for processing other than file reading (READ), writing (WRITE), or directory reading (READDIR), the file sharing server program 406 of the new NAS 111 executes processing in step S206 and subsequent steps.

In step S203, the file sharing server program 406 of the new NAS 111 judges what object type the target of the request from the client 101 is (S203). If it is determined in step S203 that the object type is a directory, the file sharing server program 406 of the new NAS 111 executes directory migration processing (S204). On the other hand, if it is determined in step S203 that the object type is a file, the file sharing server program 406 of the new NAS 111 executes file migration processing (S205). The details of the directory migration processing in step S204 and the file migration processing in step S205 will be explained later.

Then, the file sharing server program 406 of the new NAS 111 executes the operation requested by the client 101 on the directory or file, on which the migration processing is executed (S206), and returns the execution results to the client 101 (S207).

Next, the directory migration processing in step S204 of FIG. 8 will be explained. The directory migration processing is processing executed by cooperation between the old file server migration processing program 411 of the old NAS 102 and the new file server migration processing program 412 of the new NAS 111.

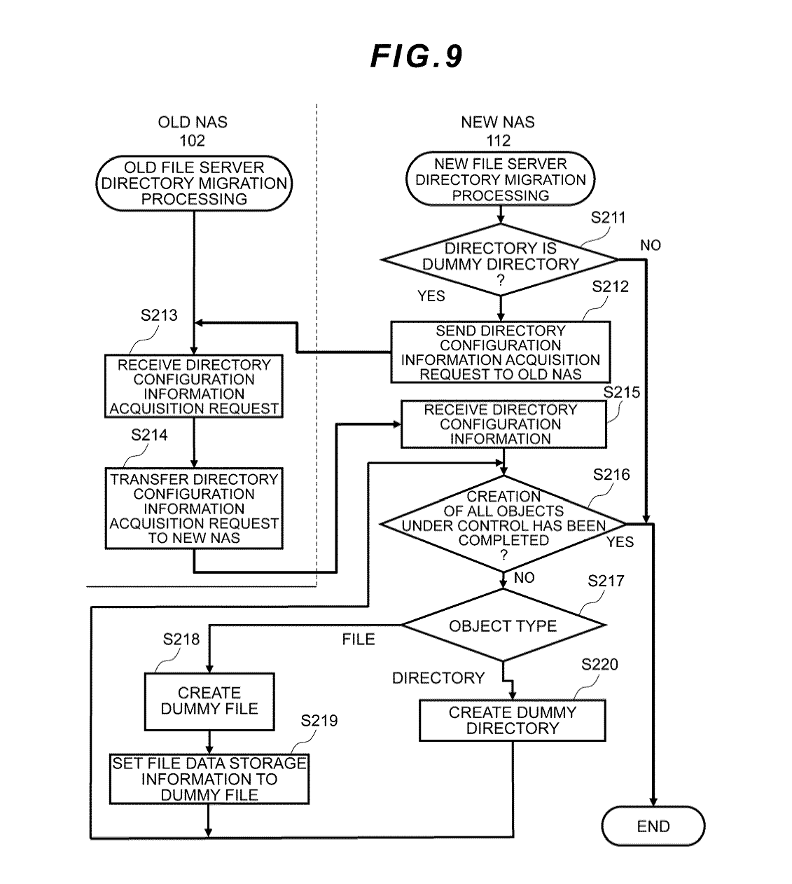

As shown in FIG. 9, the new file server migration processing program 412 of the new NAS 111 firstly judges whether the directory which is the target of the request from the client 101 is a dummy directory or not (S211). Whether it is a dummy directory or not is judged by checking whether the target directory is an empty directory which is created temporarily, for example, by checking if the directory has a flag indicating whether each directory is a dummy directory or not. If it is determined in step S211 that the target directory is a dummy directory, the new file server migration processing program 412 of the new NAS 111 sends a directory configuration information acquisition request to the old NAS 102 (S212). On the other hand, if it is determined in step S211 that the target directory is not a dummy directory, data of the target directory is already stored in the new NAS 111, so that the new file server migration processing program 412 of the new NAS 111 terminates the directory migration processing.

Then, the old file server migration processing program 411 of the old NAS 102 receives the directory configuration information acquisition request sent from the new NAS 111 in step S212 (S213). Then, the old file server migration processing program 411 of the old NAS 102 transfers the directory configuration information 413 to the new NAS 111 (S214).

Then, the new file server migration processing program 412 of the new NAS 111 receives the directory configuration information 413 sent from the old NAS 102 in step S214 (S215). Then, the new file server migration processing program 412 of the new NAS 111 judges whether or not all objects under the request target directory are created (S216). Whether the objects are created or not is judged in step S216 by checking whether or not dummy files or dummy directories are created with respect to the objects (files or directories) under the request target directory.

If it is determined in step S216 that the creation of all the objects has been completed, the new file server migration processing program 412 of the new NAS 111 terminates the directory migration processing. On the other hand, if it is determined in step S216 that the creation of all the objects has not been completed, the new file server migration processing program 412 of the new NAS 111 judges the type of the object under the request target directory (S217).

If it is determined in step S217 that the type of the object under the request target directory is a file, the new file server migration processing program 412 of the new NAS 111 creates a dummy file (S218) and sets file data storage information corresponding to that file to the dummy file (S219).

Furthermore, if it is determined in step S217 that the type of the object under the request target directory is a directory, the new file server migration processing program 412 of the new NAS 111 creates a dummy directory (S220).

Next, the file migration processing in step S205 of FIG. 8 will be explained. The file migration processing is processing executed by cooperation between the old file server migration processing program 411 of the old NAS 102, the new file server migration processing program 412 of the new NAS 111, and the CAS file migration processing program 510 of the CAS 121.

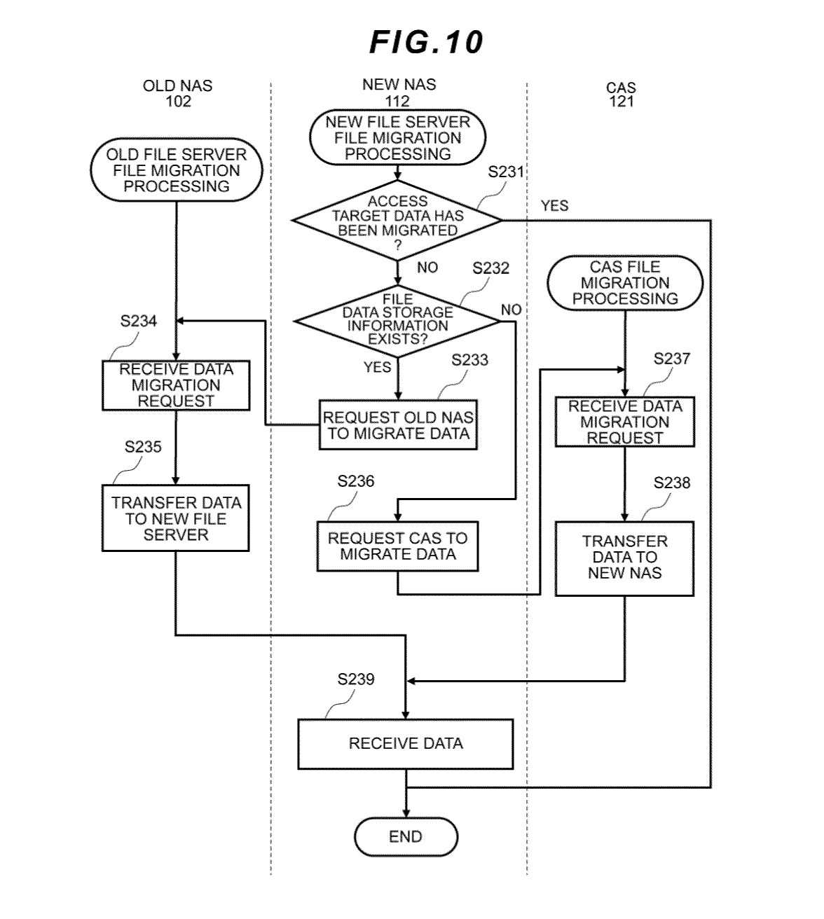

As shown in FIG. 10, the new file server migration processing program 412 of the new NAS 111 firstly judges whether the file data which is an access target has already been migrated or not (S231). If it is determined in step 231 that the file data which is the access target has already been migrated, the new file server migration processing program 412 of the new NAS 111 terminates the file migration processing.

On the other hand, if it is determined in step S231 that the file data which is the migration target has not been migrated, the new file server migration processing program 412 of the new NAS 111 judges whether the file data storage information of the target file exists or not (S232). If it is determined in step S232 that the file data storage information exists, the new file server migration processing program 412 of the new NAS 111 checks if the file data storage information is stored in the file data storage information column 4134 of the directory configuration information 413 in FIG. 3 and the file data storage information is set to the relevant file.

If it is determined in step S232 that the file data storage information exists, that is, if it is determined that the file data of the target file is stored in the old NAS 102, the new file server migration processing program 412 of the new NAS 111 requests the old NAS 102 to migrate the file data of the target file (S233). On the other hand, if it is determined in step S232 that the file data storage information does not exist, that is, the file data of the target file is not stored in the old NAS 102, the new file server migration processing program 412 of the new NAS 111 requests the CAS 121 to migrate the file data of the target file (S236).

The old file server migration processing program 411 of the old NAS 102 which was requested by the new NAS 111 to migrate the file data of the target file in step S233 receives the request to migrate that data (S234). Then, the old file server migration processing program 411 of the old NAS 102 transfers the relevant data to the new NAS 111 (S235).

Furthermore, the CAS file migration processing program 510 of the CAS 121 which was requested by the new NAS 111 to migrate the file data of the target file in step S236 receives the request to migrate that data (S237). Then, the CAS file migration processing program 510 of the CAS 121 transfers the relevant data to the new NAS 111 (S238).

Then, the new file server migration processing program 412 of the new NAS 111 receives the data transferred from the old NAS 102 or the CAS 121 (S239) and terminates the file migration processing.

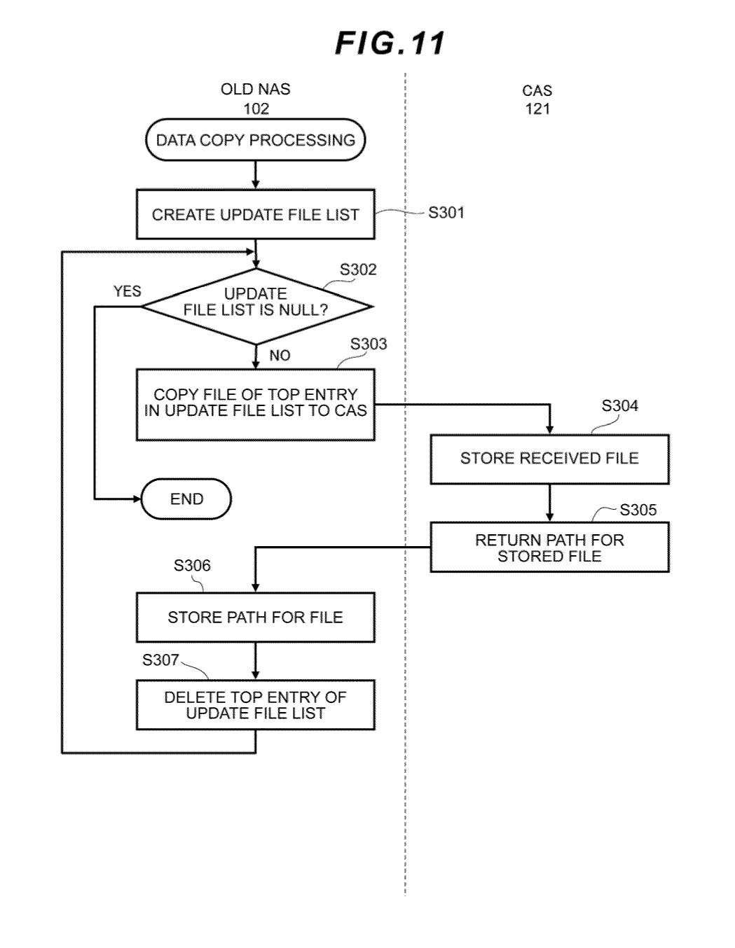

Next, the data copy processing from the old NAS 102 to the CAS 121 before the NAS migration will be explained with reference to FIG. 11. The data copy program 408 of the old NAS 102 firstly creates an update file list (not shown) (S301). The update file list created in step S301 is a list of files and directories updated by the client 101.

Then, the data copy program 408 of the old NAS 102 judges whether the update file list is NULL or not, that is, whether the file update information is stored in the update file list or not (S302). If it is determined in step S302 that the update information is not stored in the update file list of the old NAS 102, the data copy program 408 of the old NAS 102 terminates the data copy processing.

On the other hand, if it is determined in step S302 that the update information is stored in the update file list, a file in the top entry of the update file list is copied to the CAS 121 (S303).

Then, the CAS 121 stores the file, which is received from the old NAS 102, in the disks 524 (S304). Then, the CAS 121 returns a path for the file stored in the disks 524 to the old NAS 102 (S305).

The data copy program 408 of the old NAS 102 stores the path for the file, which was returned from the CAS 121 in step S305, in the disks 424 (S306). Then, the data copy program 408 of the old NAS 102 deletes the top entry of the update file list (S307) and repeats the processing in step S302 and subsequent steps.

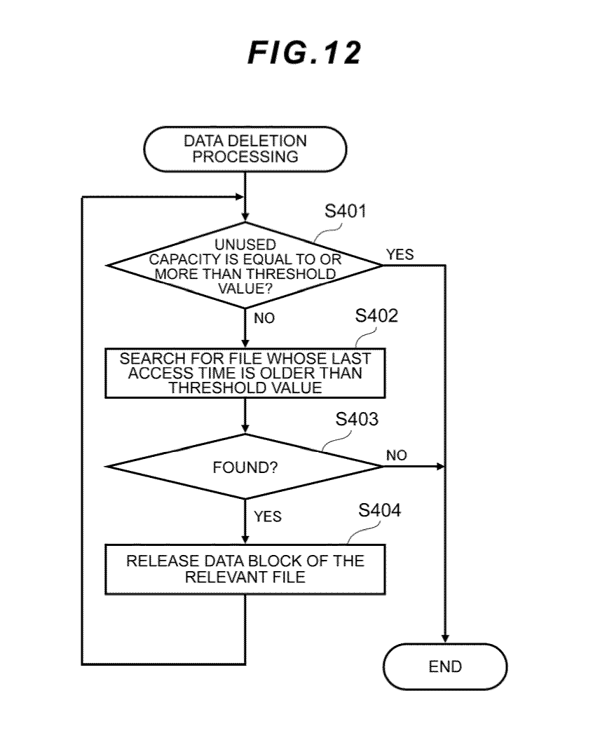

Next, the processing for deleting the data copied from the old NAS 102 to the CAS 121 in FIG. 10 will be explained. As shown in FIG. 12, the file system program 409 of the old NAS 102 judges whether an unused capacity is equal to or more than a threshold value or not (S401). If it is determined in step S401 that the unused capacity is equal to or more than the threshold value, the file system program 409 of the old NAS 102 terminates the data deletion processing.

On the other hand, if it is determined in step S401 that the unused capacity is less than the threshold value, the file system program 409 of the old NAS 102 searches for a file whose last access time is older than the threshold value (S402). In step S402, a file which has not been accessed by the client 101 lately can be searched by searching for the file whose last access time is older than the threshold value.

Subsequently, the file system program 409 of the old NAS 102 judges whether the file which satisfies the condition of step S402 has been found or not (S403). If it is determined in step S403 that the file which satisfies the condition has not been found, the file system program 409 of the old NAS 102 terminates the processing.

On the other hand, if it is determined in step S403 that the file which satisfies the condition has been found, the file system program 409 of the old NAS 102 releases a data block of the file which satisfies the condition (S404), and repeats the processing in step S401 and subsequent steps. In step S404, the file data of the relevant file of the old NAS 102 is deleted and a stub of the relevant file is formed by releasing the data block of the file which satisfies the condition.

The stub formation herein used means that only metadata such as the storage location of the relevant file is retained and the entity of the file data is retained by another storage apparatus. In the case of this embodiment, all pieces of the file data of the old NAS 102 are copied to the CAS 121 and the old NAS 102 retains the path (storage location) for the file stored in the CAS 121. Therefore, when the data block of the file is released in step S404 described above, the file data of the relevant file is deleted from the old NAS 102, the metadata such as the path for the relevant file is retained, and the stub is formed.

### (1-4) Advantageous Effect of This Embodiment

If the data of the file stored in the old NAS 102 is stored in the CAS 121 according to this embodiment as described above, the new NAS 111 which is the migration destination decides the old NAS 102 or the CAS 112 to be the transfer request destination for the data of the relevant file when migrating the old NAS 102, based on the file data storage information indicating whether the data of the file is stored in the old NAS 102 or not. As a result, the file server migration processing can be executed efficiently by migrating the data by using cache date of the file server; and therefore, response performance can be enhanced by reducing the network traffic at the time of migration of the file server.

### (2) Second Embodiment

### (2-1) Outline of This Embodiment

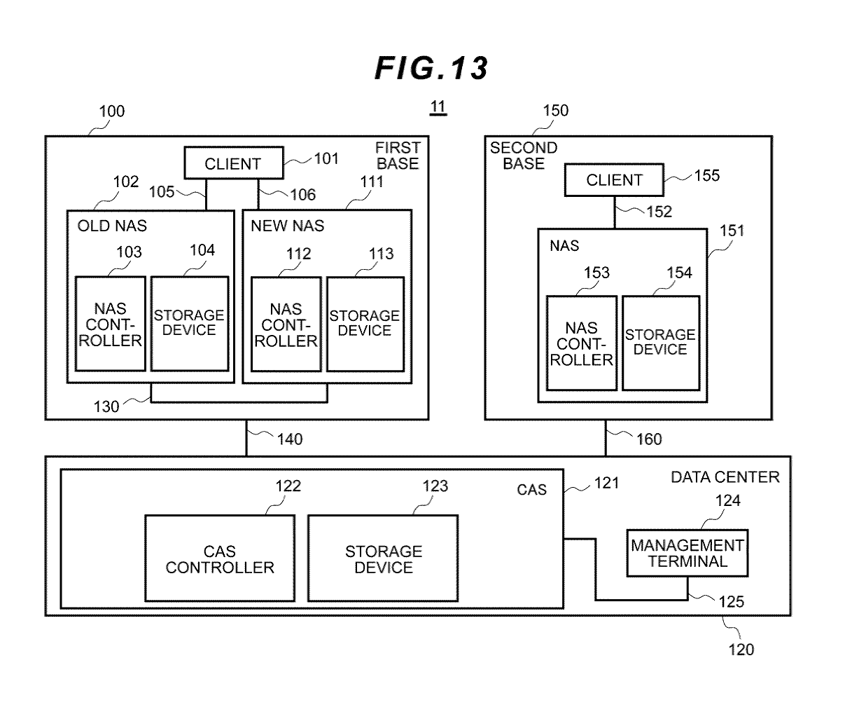

In this embodiment as shown in FIG. 13, another base separate from the base 100 is connected to the data center 120 via a WAN 160. The base 100 will be referred to as the first base 100 and another base separate from the first base 100 will be referred to as the second base 150 in the following explanation. This embodiment describes that the two bases are connected to the data center 120; however, the embodiment is not limited to this example and more than two bases may be connected to the data center 120.

Furthermore, in this embodiment, NAS devices of the first base 100 and a NAS device of the second base 150 share the same files. Then, the data migration processing from the old file server (the old NAS 102) to the new file server (the new NAS 111) is executed at the first base 100 in the same manner as the first embodiment due to, for example, performance deficiency of the file server.

Then, the file data acquisition location is changed depending on whether the file data requested by the client 101 is stored in the old NAS 102 or not, in the same manner as in the first embodiment. However, if the first base 100 and the second base 150 share the same files as shown in FIG. 13, it is possible that the file data may be updated at the second base 150 in response to a request from the client 155. In this case, if the file acquisition location is changed based only on the information about whether the file data is stored in the old NAS 102 or not as in the first embodiment, there is a possibility that the file data update information at the second base 150 may not be reflected in the data migrated to the new NAS 111.

If the file data is copied from the old NAS 102 to the CAS 121, the file data of the old NAS 102 is treated as cache data. The file data in the old NAS 102 treated as the cache data is data to be deleted as necessary. Furthermore, if the file data of that file in the NAS 151 of the second base 150 is updated, the file data in the CAS 121 is updated, but the file data in the old NAS 102 is not updated. Therefore, when a plurality of bases exist as in this embodiment and if the file data is stored in the old NAS 102 at the time of migration and the file data is obtained from the old NAS 102 as in the first embodiment, there is a possibility that the file data which is not updated may be stored in the new NAS 111.

So, at the time of migration of the file data in this embodiment, the new NAS 111 decides the file data acquisition location by referring to not only the directory configuration information 413, but also the information indicating whether or not the file data has been updated at the other base (the update file list). Specifically speaking, the update file list is retained by the CAS 121 and that update file list is provided to the new NAS 11 at the time of migration of the file data. Then, the new NAS 111 refers to the directory configuration information 413 and the update file list; and if the file data is stored in the old NAS 102 and that file data has not been updated at the NAS of the other base, the new NAS 111 obtains the file data of the old NAS 102.

As a result, it is possible to effectively use the file data stored in the old NAS 102 and avoid the acquisition of the file data which has not been updated.

### (2-2) Configuration of Computer System

The detailed explanation about the same configuration as that of the first embodiment has been omitted below and any configuration different from that of the first embodiment will be explained particularly in detail. As shown in FIG. 13, not only the first base 100, but also the second base 150 is connected to the data center 120 in a computer system 11 according to this embodiment. Since the hardware configuration of the second base 150 is the same as the hardware configuration of the first base 100, any detailed explanation about it has been omitted.

### (2-2-1) Configuration of File Server

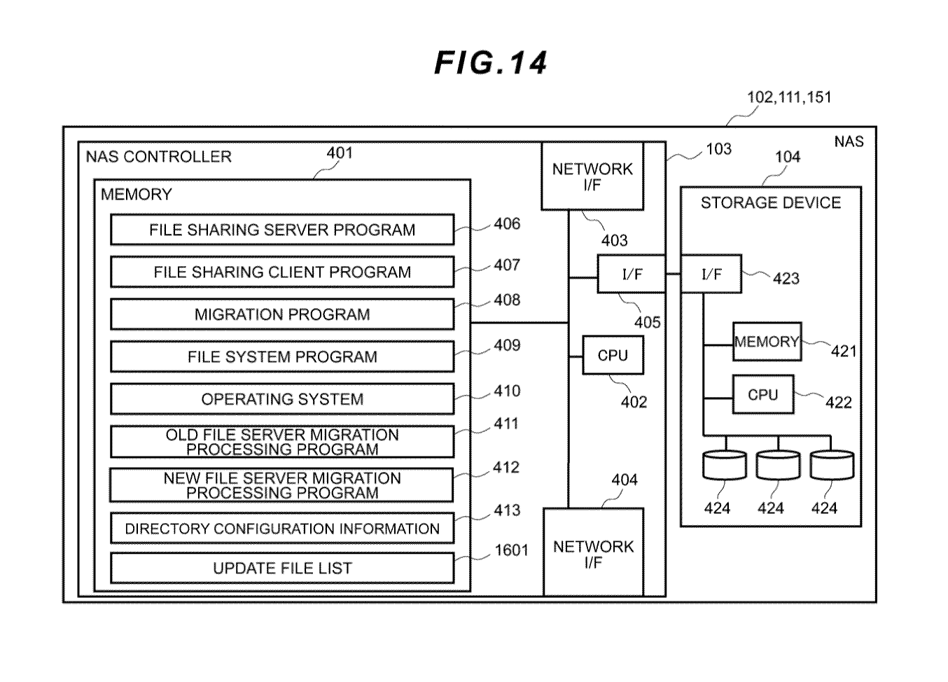

Next, the configuration of each file server (the old NAS 102 and the new NAS 111 of the first base and the NAS 151 of the second base) will be explained with reference to FIG. 14. Since the old NAS 102 and the new NAS 111 of the first base have the same hardware configuration and software configuration as those of the NAS 151 of the second base, mainly the old NAS 102 of the first base will be taken as an example and explained below.

The difference between the old NAS 102 shown in FIG. 14 and the first embodiment is that the old NAS 102 has an update file list 1601 in the memory 401. The update file list 1601 indicates information about files updated at each base as mentioned above.

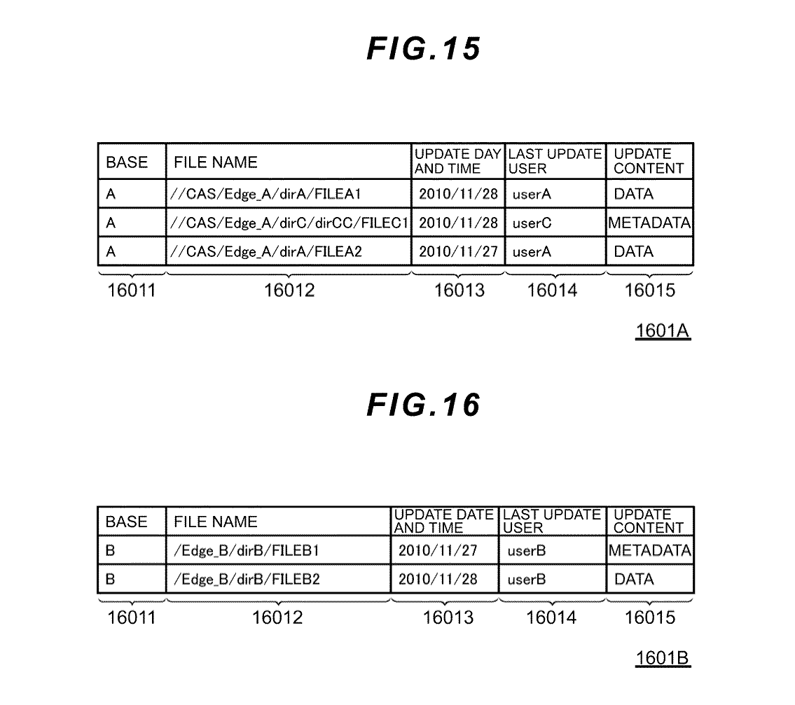

Next, the update file list 1601 will be explained. Since base A (the first base) and base B (the second base) share files as mentioned above, it is necessary to obtain information about the files updated at the other base. FIG. 15 shows file update information of base A which is recognized as the other base by base B; and FIG. 16 shows file update information of base B which is its own base for base B.

As shown in FIG. 15, an update file list 1601A is constituted from a base column 16011, a file name column 16012, an update date and time column 16013, a last update user column 16014, and an update content column 16015.

The base column 16011 stores information for identifying the relevant base. The file name column 16012 stores information indicating the storage location of the relevant file such as a file name or a path for the file. The update date and time column 16013 stores information of a date and time when the relevant file was updated. The last update user column 16014 stores information of a user who updated the relevant file last. The update content column 16015 stores information about the update content of the relevant file, for example, whether data of the file was updated or the metadata was updated.

FIG. 15 is the file update information of the other base A recognized by the NAS 151 of base B (the second base); and you can tell that, for example, data of a file with the file name FILEA1 at base A was updated by user A on Nov. 28, 2010 and the relevant file is stored under //CAS/Edge_A/dirA. Now, //CAS/Edge_A/dirA/FILEA1 in the file name column indicates that the file data of the updated file FILEA1 is stored in the CAS 120 and is stored under the directory /Edge_A/dirA/.

Furthermore, FIG. 16 is the file update information of the local base B recognized by the NAS 151 of base B (the second base); and you can tell that, for example, the metadata of a file with the file name FILEB1 of base B was updated by user B on Nov. 27, 2010 and the relevant file is stored under /Edge_B/dirB. Now, /Edge_B/dirB/FILEB1 in the file name column indicates that the metadata of the updated file FILEB1 is stored under its own directory /Edge_B/dirB/.

### (2-2-2) Configuration of Archive Device

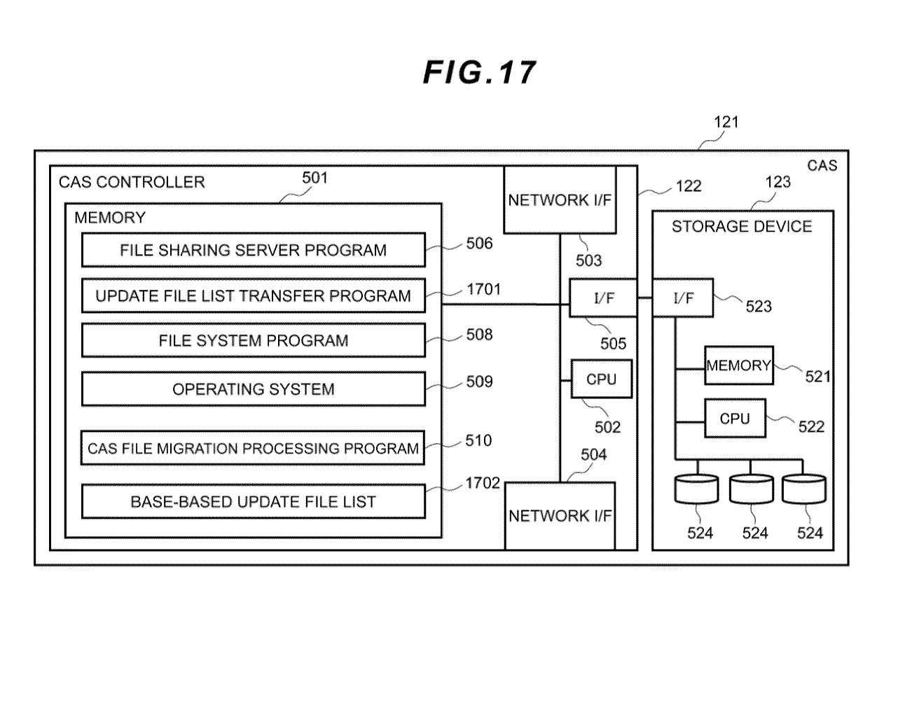

Next, the configuration of the archive device (the CAS 121) will be explained with reference to FIG. 17. The difference between the CAS 121 shown in FIG. 17 and the first embodiment is that the CAS 121 has a base-based update file list 1702 in the memory 501. The base-based update file list 1702 shows information of files updated at each base as mentioned above.

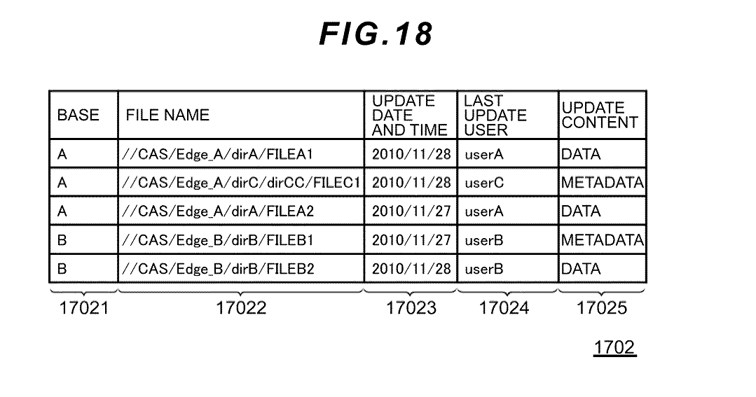

The base-based update file list 1702 will be explained with reference to FIG. 18. Files updated at each base are stored in the CAS 121 of the data center 120. The CAS 121 stores the information of the updated files in the base-based update file list 1702.

As shown in FIG. 18, the update file list 1702 is constituted from a base column 17021, a file name column 17022, an update date and time column 17023, a last update user column 17024, and an update content column 17025.

The base column 17021 stores information for identifying the relevant base. The file name column 17022 stores information indicating the storage location of the relevant file such as a file name or a path for the file. The update date and time column 17023 stores information of a date and time when the relevant file was updated. The last update user column 17024 stores information of a user who updated the relevant file last. The update content column 17025 stores information about the update content of the relevant file, for example, whether data of the file was updated or the metadata was updated.

Referring to FIG. 18, you can tell that, for example, data of a file with the file name FILEA1 at base A was updated by user A on Nov. 28, 2010 and the relevant file is stored under //CAS/Edge_A/dirA. Now, //CAS/Edge_A/dirA/FILEA1 in the file name column indicates that the file data of the updated file FILEA1 is stored in the CAS 120 and is stored under the directory /Edge_A/dirA/.

### (2-3) Data Migration Processing in Computer System

### (2-3-1) Outline of Data Migration Processing

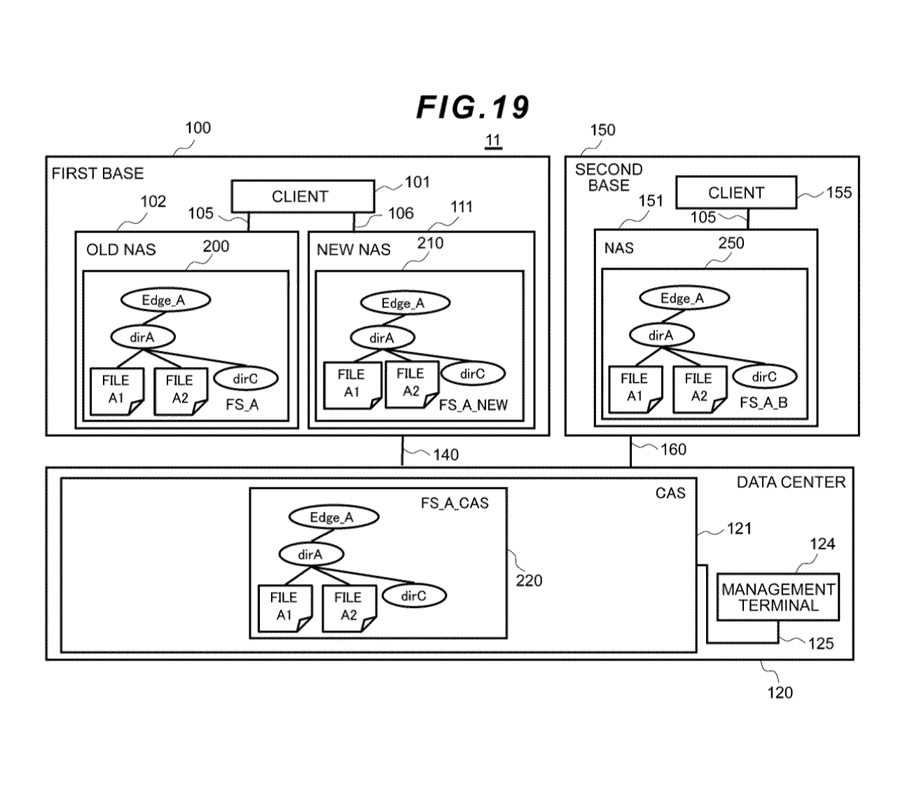

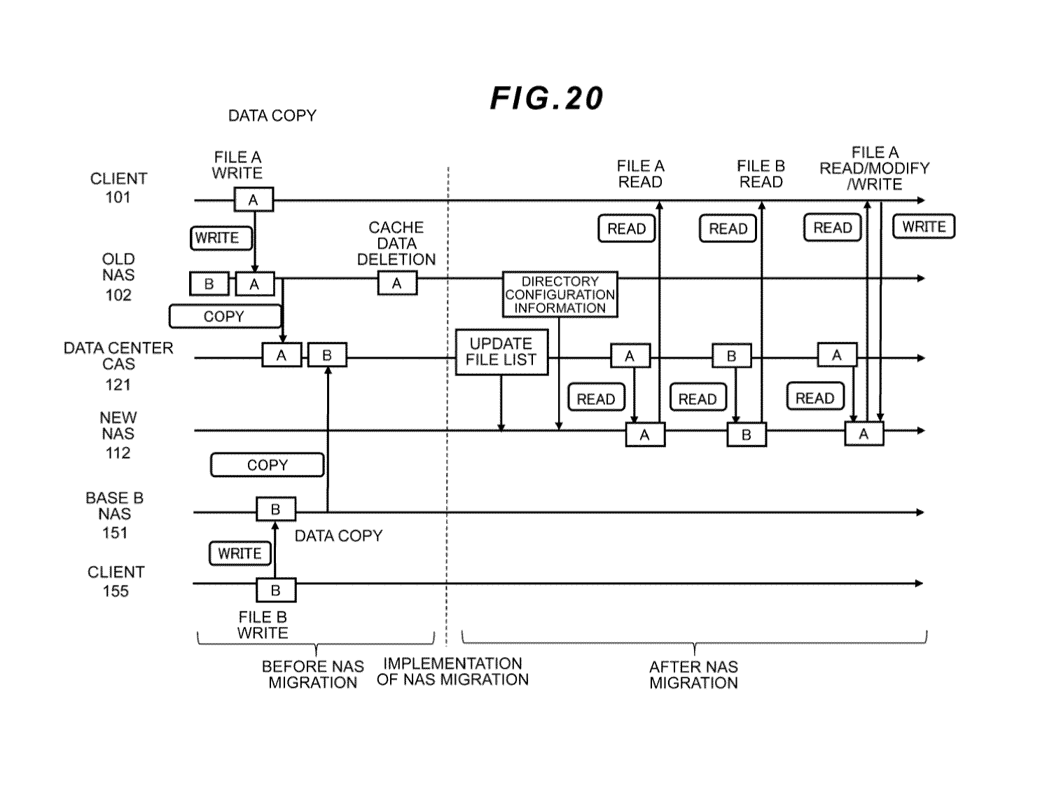

Next, the outline of data migration processing in the computer system 11 will be explained with reference to FIG. 19 and FIG. 20. As shown in FIG. 19, a file system of each file server of the first base 100 and the second base 150 (the old NAS 102 and the new NAS 111 of the first base 100, and the NAS 151 of the second base 150) stores a plurality of directories and files.

Specifically speaking, the file server (the old NAS 102 or the new NAS 111) includes a file system named FS_A or FS_A_NEW and the highest directory of FS_A or FS_A_NEW is Edge_A. Edge_A is associated with directory dirA and directory dirA is associated with file FILEA1, file FILEA2, and directory dirC. Furthermore, the CAS 121 also includes a file system FS_A_CAS and the highest directory of FS_A_CAS is Edge_A. Edge_A is associated with directory dirA and directory dirA is associated with file FILEA1, file FILEA2, and directory dirC.

Then, when data is written (WRITE) from the client 101 to file A before the NAS replacement (migration) as shown in FIG. 20, file data of file A is written to the old NAS 102.

Subsequently, the file data of file A is copied to the CAS 121 of the data center 120. After the file data of file A is copied to the CAS 121, the file data of the old NAS 102 is treated as cache data. Specifically speaking, since the file data of file A is stored in the CAS 121, the file data of file A, which is stored in the old NAS 102, is deleted as necessary. Then, the cache data of file A stored in the old NAS 102 is deleted.

On the other hand, when data is written (WRITE) from the client 101 to file B before the NAS replacement (migration), file data of file B is written to the NAS 151 of the second base 150.

Subsequently, the file data of file B is copied to the CAS 121 of the data center 120. After the file data of file B is copied to the CAS 121, the file data of the NAS 151 is treated as cache data. Specifically speaking, since the file data of file B is stored in the CAS 121, the file data of file B, which is stored in the NAS 151, is deleted as necessary.

Then, when the NAS migration processing is executed, the update file list (the base-based update file list 1702) mentioned above in FIG. 18 is sent from the CAS 121 to the new NAS 111. Also, the directory configuration information 413 in FIG. 3 is sent from the old NAS 102 to the new NAS 111 in the same manner as in the first embodiment. The new NAS 111 refers to the update file list 1702 and the directory configuration information 413 and judges whether to migrate the file from the CAS 121 or to migrate the file from the old NAS 102.

After the migration processing from the old NAS 102 to the new NAS 111 is executed, the client 101 switches the access location from the old NAS 102 to the new NAS 111. Having received a request for file READ processing from the client 101, the new NAS 111 selects either the old NAS 102 or the CAS 121 as a file data acquisition location by referring to the update file list 1702 and the directory configuration information 413.

Having received a request for the READ processing for reading file A or file B from the client 101, the new NAS 111 determines the acquisition location to obtain the file data of file A or file B by referring to the update file list 1702 and the directory configuration information 413. Then, the new NAS 111 reads the file data of file A from the CAS 121. Furthermore, since the file data of file B is stored in the old NAS 102, but the file is updated at the NAS 151 of the second base 150, the new NAS 111 reads the latest file data stored in the CAS 102.

Similarly, if the client 101 issues a request for WRITE processing for writing data to file A or file B, the new NAS 111 refers to the update file list 1702 and the directory configuration information 413 and reads the file data of file A from the CAS 121 (READ), changes the file data (MODIFY), and writes the changed file A to the new NAS 111 (WRITE). Furthermore, the new NAS 111 refers to the directory configuration information 413, reads the file data of file B from the old NAS 102 (READ), changes the file data (MODIFY), and writes the changed file B to the new NAS 111 (WRITE).

During the on-demand restoration processing from the old NAS 102 to the new NAS 111, the new NAS 111 obtains not only the storage location information about the file requested by the client 101, but also information indicating whether the relevant file has been updated by the NAS of the other base or not; and if the cache data of the relevant file remains and the file has not been updated at the other base, the new NAS 111 accesses the old NAS 102; and if the cache data of the relevant file remains, but the file has been updated at the other base, the new NAS 111 accesses the CAS 121. In this way, even when files are shared between a plurality of bases, the cache data of the old NAS 102 can be used effectively by referring to the update file list 1702 and the directory configuration information 413 at the time of the NAS migration and accessing either the old NAS 102 or the CAS 121.

### (2-3-2) Details of Migration Processing

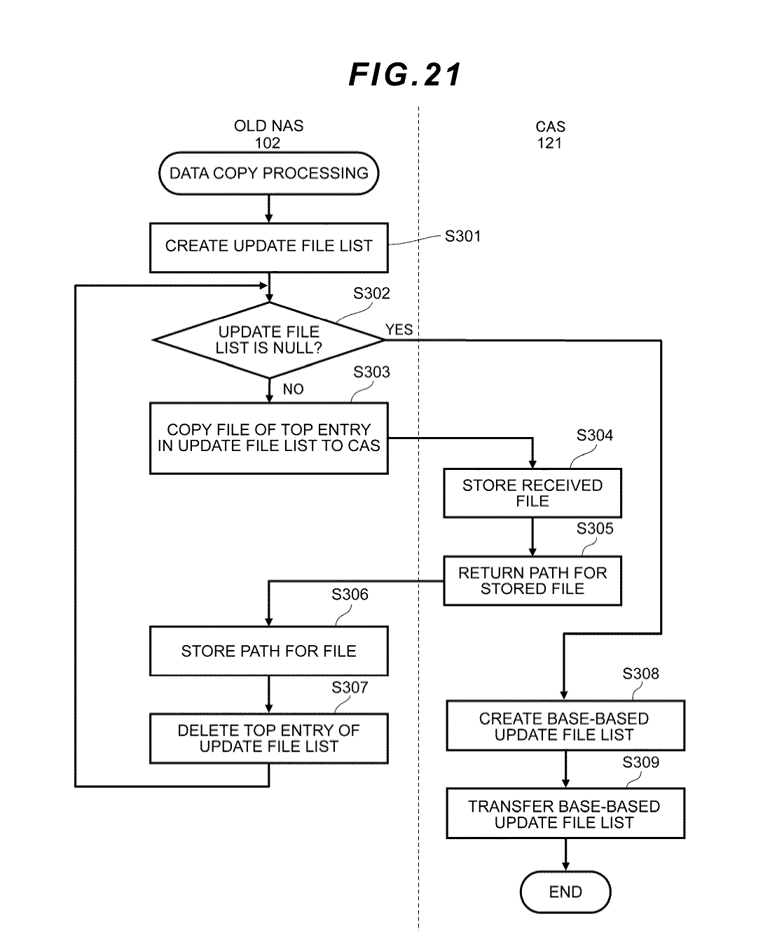

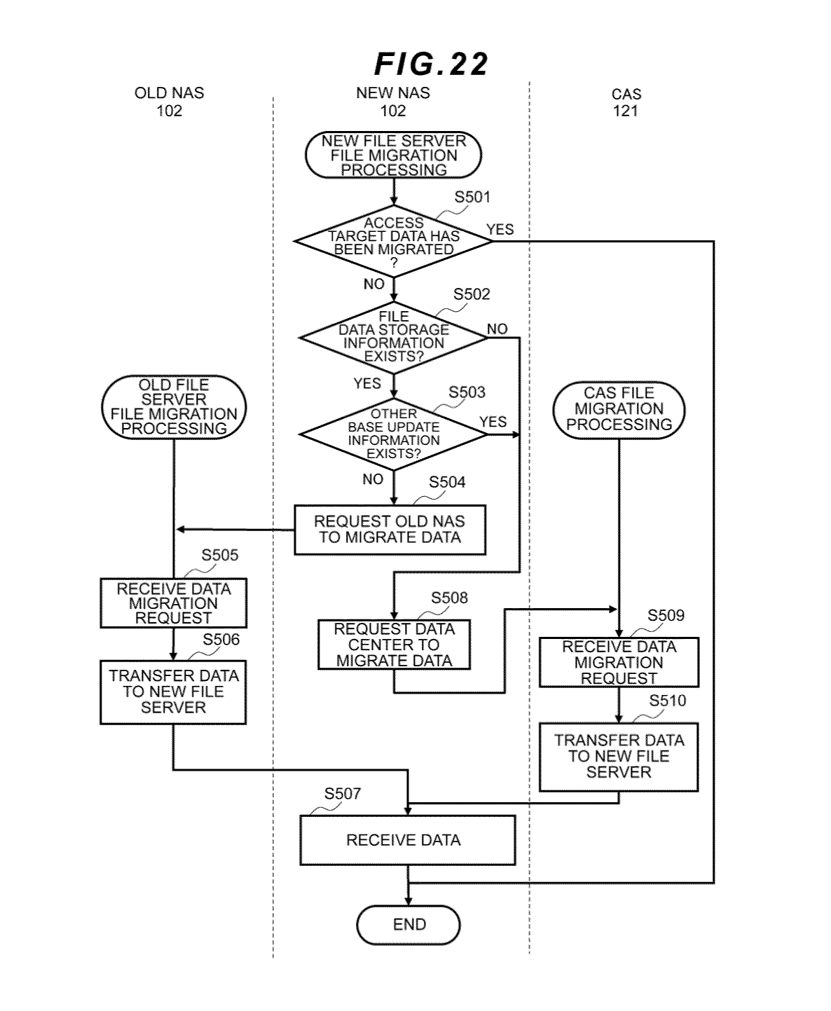

Next, the details of migration processing from an old file server (the old NAS 102) to a new file server (the new NAS 111) will be explained with reference to FIG. 21 and FIG. 22. The difference between the second embodiment and the first embodiment will be explained in detail below and any detailed explanation about the same processing as that of the first embodiment has been omitted. The difference between this embodiment and the first embodiment is that files are shared between a plurality of bases and reference is made to the file update information at each base at the time of the NAS migration.

Firstly, processing for creating the base-based update file list will be explained with reference to FIG. 21 and then the details of the file migration processing will be explained with reference to FIG. 22.

As shown in FIG. 21, the data copy program 408 of the old NAS 102 firstly creates the update file list (not shown) (S301). The update file list created in step S301 is a list of data updated by the client 101.

Then, the data copy program 408 of the old NAS 102 judges whether the update file list is NULL or not, that is, whether the file update information is stored in the update file list or not (S302). If it is determined in step S302 that the update file list is not created, the data copy program 408 of the old NAS 102 terminates the data copy processing.

On the other hand, if it is determined in step S302 that the update information is stored in the update file list, a file in the top entry of the update file list is copied to the CAS 121 (S303).

Then, the CAS 121 stores the file, which is received from the old NAS 102, in the disks 524 (S304). Then, the CAS 121 returns a path for the file stored in the disks 524 to the old NAS 102 (S305).

The data copy program 408 of the old NAS 102 stores the path for the file, which was returned from the CAS 121 in step S305, in the disks 424 (S306). Then, it deletes the top entry of the update file list (S307) and repeats the processing in step S302 and subsequent steps.

Then, if it is determined in step S302 that the update file list is NULL, that is, the file update information is not stored in the update file list of the old NAS 102, the data copy program 408 of the old NAS 102 notifies the CAS 121 of the judgment result. The CAS 121 receives the notice from the old NAS 102 and creates the base-based update file list 1702 of files updated at the old NAS 102 (S308). Then, the CAS 121 transfers the base-based update file list 1702 to the new NAS 111 where the migration processing is executed (S309).

Next, the file migration processing will be explained with reference to FIG. 22. The file migration processing is processing executed by cooperation between the old file server migration processing program 411 of the old NAS 102, the new file server migration processing program 412 of the new NAS 111, and the CAS file migration processing program 510 of the CAS 121.

As shown in FIG. 22, the new file server migration processing program 412 of the new NAS 111 firstly judges whether the file data which is an access target has already been migrated or not (S501). If it is determined in step 501 that the file data which is the access target has already been migrated, the new file server migration processing program 412 of the new NAS 111 terminates the file migration processing.

On the other hand, if it is determined in step S501 that the file data which is the migration target has not been migrated, the new file server migration processing program 412 of the new NAS 111 judges whether the file data storage information of the target file exists or not (S502). If it is determined in step S502 that the file data storage information exists, the new file server migration processing program 412 of the new NAS 111 checks if the file data storage information is stored in the file data storage information column 4134 of the directory configuration information 413 in FIG. 3 and the file data storage information is set to the relevant file.

If it is determined in step S502 that the file data storage information exists, that is, if it is determined that the file data of the target file is stored in the old NAS 102, the new file server migration processing program 412 of the new NAS 111 judges whether other base update information of the target file exists or not (S503). Specifically speaking, the new file server migration processing program 412 of the new NAS 111 judges whether or not the update information of the target file is stored in the base-based update file list 1702 transferred from the CAS 121. The other base update information is transferred from the CAS 121 to the new NAS 11 after switching the NAS as described above.

On the other hand, if it is determined in step S502 that the file data storage information does not exist, that is, the file data of the target file is not stored in the old NAS 102, the new file server migration processing program 412 of the new NAS 111 executes processing in step S508 and subsequent steps.

If it is determined in step S503 that the other base update information of the target file does not exist, that is, the update information of the target file is not stored in the base-based update file list 1702, the new file server migration processing program 412 of the new NAS 111 requests the old NAS 102 to migrate the file data of the target file (S504).

On the other hand, if it is determined in step S503 that the other base update information of the target file exists, that is, the update information of the target file is stored in the base-based update file list 1702, the new file server migration processing program 412 of the new NAS 111 requests the CAS 121 to migrate the file data of the target file (S508). Also, if it is determined in step S502 that the file data of the target file is not stored in the old NAS 102, the new file server migration processing program 412 of the new NAS 111 requests the CAS 121 to migrate the file data of the target file (S508).

The old file server migration processing program 411 of the old NAS 102 which was requested by the new NAS 111 to migrate the file data of the target file in step S504 receives the request to migrate that data (S505). Then, the old file server migration processing program 411 of the old NAS 102 transfers the relevant data to the new NAS 111 (S506).

Furthermore, the CAS file migration processing program 510 of the CAS 121 which was requested by the new NAS 111 to migrate the file data of the target file in step S508 receives the request to migrate that data (S509). Then, the CAS file migration processing program 510 of the CAS 121 transfers the relevant data to the new NAS 111 (S510).

Then, the new file server migration processing program 412 of the new NAS 111 receives the data transferred from the old NAS 102 or the CAS 121 (S507) and terminates the file migration processing.

### (2-4) Advantageous Effect of This Embodiment

When files are shared by NASs at a plurality of bases according to this embodiment as described above, the file update information at each base is stored in the CAS 121; and when data is to be migrated from the old NAS 102 at a certain base to the new NAS 111 and even if a file is shared by the NASs at the plurality of bases, the new NAS 111 can use cache data of the old NAS 102 effectively and avoid the acquisition of file data, which has not been updated, by accessing either the old NAS 102 or the CAS 121 by referring to the file update information of other bases in addition to the file storage information indicating whether or not data of the relevant file is stored in the old NAS 102.

### (3) Third Embodiment

### (3-1) Outline of This Embodiment

In this embodiment, another base separate from the base 100 is connected to the data center 120 via a WAN in the same manner as the second embodiment. In the second embodiment, the update file list of each base is retained by the data center 120 and the file update information is transferred from the data center 120 to each base at the time of the file server migration; however, in this embodiment, a file server which is a migration source retains the file update information of the other base. Then, when migrating the file server, whether the migration target file has been updated or not is reported to a file server which is a migration destination. Furthermore, the migration source file server may create a file update list of the other base and transfer that update list to the migration destination file server.

### (3-2) Configuration of Computer System

In the following explanation, any detailed explanation about the same configuration as that of the second embodiment has been omitted and the configuration different from that of the second embodiment will be explained particularly in detail below. Since the configuration of the computer system 11 according to this embodiment is the same as that of the second embodiment, any detailed explanation about it has been omitted.

### (3-2-1) Configuration of File Server

The configuration of the file server is almost the same as that of the second embodiment and the difference between the configuration of the file server according to this embodiment and the second embodiment is that the directory configuration information 413 of the old NAS 102 stores different information.

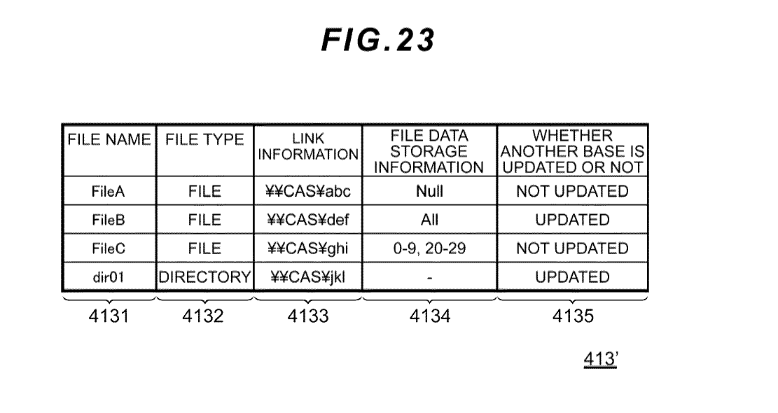

Specifically speaking, as shown in FIG. 23, the directory configuration information 413 includes a whether-another-base-is-updated-or-not column 4135 in addition to the file name column 4131, the file type column 4132, the link information column 4133, and the file data storage information column 4134.

The whether-another-base-is-updated-or-not column 4135 stores information indicating whether a file has been updated at the other base. For example, referring to FIG. 23, ALL is stored in the file data storage information column 4134 of FILEB, so that the file data of FILEB is stored in the old NAS 102; however, since Updated is stored in the whether-another-base-is-updated-or-not column 4135, you can tell that an update has been performed at the other base. In this case, the file data of FILEB stored in the old NAS 102 is pre-update data, so that it is necessary to obtain the migration target file data from the CAS 121.

In this way, the migration target file update information may be managed by providing the whether-another-base-is-updated-or-not column 4135 in the directory configuration information 413; or the migration target file update information may be managed based on the update list by retaining the update list separately from the directory configuration information 413.

### (3-2-2) Configuration of Archive Device

Since the configuration of the archive device (the CAS 121) according to this embodiment is the same as that of the second embodiment, any detailed explanation about it has been omitted.

### (3-3) Data Migration Processing in Computer System

### (3-3-1) Outline of Data Migration Processing

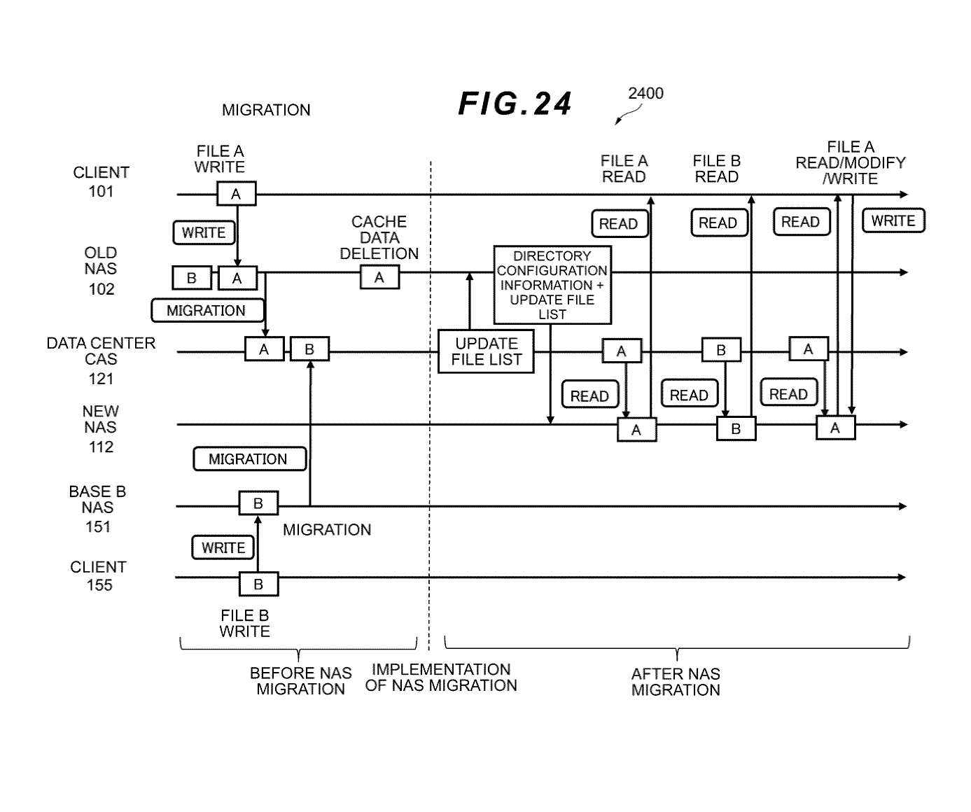

Next, the outline of the data migration processing in the computer system 11 will be explained with reference to FIG. 24. Particularly, processing different from that of the second embodiment will be explained in detail.

When data is written (WRITE) from the client 101 to file A before the NAS replacement (migration) as shown in FIG. 24, file data of file A is written to the old NAS 102.

Subsequently, the file data of file A is copied to the CAS 121 of the data center 120. After the file data of file A is copied to the CAS 121, the file data of the old NAS 102 is treated as cache data. Specifically speaking, since the file data of file A is stored in the CAS 121, the file data of file A, which is stored in the old NAS 102, is deleted as necessary. Then, the cache data of file A stored in the old NAS 102 is deleted.

On the other hand, when data is written (WRITE) from the client 155 to file B before the NAS replacement (migration), file data of file B is written to the NAS 151 of the second base 150.

Subsequently, the file data of file B is copied to the CAS 121 of the data center 120. After the file data of file B is copied to the CAS 121, the file data of the NAS 151 is treated as cache data. Specifically speaking, since the file data of file B is stored in the CAS 121, the file data of file B, which is stored in the NAS 151, is deleted as necessary.

Then, when the NAS migration processing is executed, the update file list (the update file list) is sent from the CAS 121 to the old NAS 102. Also, the directory configuration information 413 including the file update information is sent from the old NAS 102 to the new NAS 111 in the same manner as in the first embodiment. The new NAS 111 refers to the directory configuration information 413 including the file update information and judges whether to migrate the file from the CAS 121 or to migrate the file from the old NAS 102.

After the migration processing from the old NAS 102 to the new NAS 111 is executed, the client 101 switches the access location from the old NAS 102 to the new NAS 111. Having received a request for file READ processing from the client 101, the new NAS 111 selects either the old NAS 102 or the CAS 121 as a file data acquisition location by referring to the directory configuration information 413 including the file update information.

Having received a request for the READ processing for reading file A or file B from the client 101, the new NAS 111 determines the acquisition location to obtain the file data of file A or file B by referring to the directory configuration information 413 including the file update information. Then, the new NAS 111 reads the file data of file A from the CAS 121. Furthermore, since the file data of file B is stored in the old NAS 102, but the file is updated at the NAS 151 of the first base 150, the new NAS 111 reads the latest file data stored in the CAS 102.

Similarly, when the client 101 issues a request for WRITE processing for writing data to file A or file B, the new NAS 111 refers to the directory configuration information 413 including the file update information and reads the file data of file A from the CAS 121 (READ), changes the file data (MODIFY), and writes the changed file A to the new NAS 111 (WRITE). Furthermore, the new NAS 111 refers to the directory configuration information 413, reads the file data of file B from the old NAS 102 (READ), changes the file data (MODIFY), and writes the changed file B to the new NAS 111 (WRITE).

During the on-demand restoration processing from the old NAS 102 to the new NAS 111, the new NAS 111 obtains not only the storage location information about the file requested by the client 101, but also information indicating whether the relevant file has been updated by the NAS of the other base or not; and if the cache data of the relevant file remains and the file has not been updated by the other base, the new NAS 111 accesses the old NAS 102; and if the cache data of the relevant file remains, but the file has been updated by the other base, the new NAS 111 accesses the CAS 121. In this way, even when files are shared between the NASs at a plurality of bases, the cache data of the old NAS 102 can be used effectively by referring to the update file list and the directory configuration information 413 at the time of the NAS migration and accessing either the old NAS 102 or the CAS 121.

### (3-3-2) Details of Migration Processing

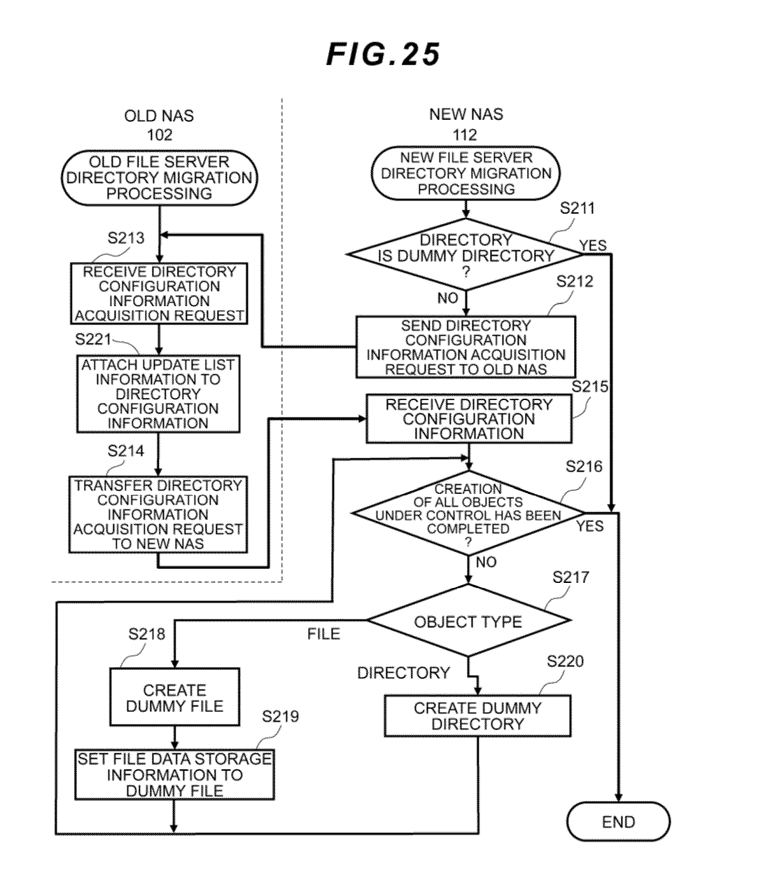

Next, the details of the migration processing from an old file server (the old NAS 102) to a new file server (the new NAS 111) will be explained with reference to FIG. 25. In the following explanation, processing different from that of the second embodiment will be explained in detail and any detailed explanation about the same processing as that of the second embodiment has been omitted.

The difference between this embodiment and the second embodiment is that file update information is added to the directory configuration information 413 of the old NAS 102 and the directory configuration information 413 including the file update information is transferred from the old NAS 102 to the new NAS 111. Specifically speaking, during the directory migration processing, the file update information is added to the directory configuration information 413 at the old NAS 102 and that directory configuration information 413 is transferred to the new NAS 111. The processing different from the directory migration processing shown in FIG. 9 will be explained in detail.

As shown in FIG. 25, the new file server migration processing program 412 of the new NAS 111 firstly judges whether a directory which is the target of the request from the client 101 is a dummy directory or not (S211). If it is determined in step S211 that the target directory is a dummy directory, the new file server migration processing program 412 of the new NAS 111 sends a directory configuration information acquisition request to the old NAS 102 (S212). On the other hand, if it is determined in step S211 that the target directory is not a dummy directory, data of the target directory is already stored in the new NAS 111, so that the new file server migration processing program 412 of the new NAS 111 terminates the directory migration processing.

Then, the old file server migration processing program 411 of the old NAS 102 receives the directory configuration information acquisition request sent from the new NAS 111 in step S212 (S213). Then, the old file server migration processing program 411 of the old NAS 102 adds the file update information to the directory configuration information 413 (S221) and transfers that directory configuration information 413 to the new NAS 111 (S214).

Then, the new file server migration processing program 412 of the new NAS 111 receives the directory configuration information 413 sent from the old NAS 102 in step S214 (S215). Then, the new file server migration processing program 412 of the new NAS 111 judges whether or not all objects under the request target directory are created (S216).

If it is determined in step S216 that the creation of all the objects has been completed, the new file server migration processing program 412 of the new NAS 111 terminates the directory migration processing. On the other hand, if it is determined in step S216 that the creation of all the objects has not been completed, the new file server migration processing program 412 of the new NAS 111 judges the type of the object under the request target directory (S217).

If it is determined in step S217 that the type of the object under the request target directory is a file, the new file server migration processing program 412 of the new NAS 111 creates a dummy file (S218) and sets file data storage information and the file update information corresponding to that file to the dummy file (S219).

Furthermore, if it is determined in step S217 that the type of the object under the request target directory is a directory, the new file server migration processing program 412 of the new NAS 111 creates a dummy directory (S220).

### (3-4) Advantageous Effect of This Embodiment

When files are shared by NASs at a plurality of bases according to this embodiment as described above, the file update information at each base is stored in an old NAS 102, which is a migration source; and when data is to be migrated from the old NAS 102 at a certain base to the new NAS 111 and even if a file is shared by the NASs at the plurality of bases, the new NAS 111 can use cache data of the old NAS 102 effectively and avoid the acquisition of file data, which has not been updated, by accessing either the old NAS 102 or the CAS 121 by referring to the file update information of other bases in addition to the file storage information indicating whether or not file data is stored in the old NAS 102.

### REFERENCE SIGNS LIST

10, 11 Computer systems
101 Client
102 Old NAS
111 New NAS
121 CAS
406 File sharing server program
407 File sharing client program
408 Data copy program
409 File system program
410 Operating system
411 Old file server migration processing program
412 New file server migration processing program
413 Directory configuration information

1. A computer system comprising:
a first file server for receiving a data input/output request from a client terminal and storing data of a target file of the data input/output request in a first storage device;
a second file server for storing data of a file, which is stored in the first storage device and sent from the first file server, in a second storage device; and
a third file server, which is a migration destination of the first file server, for storing the data of the target file of the data input/output request in a third storage device;
wherein the first file server retains, for each file, file data storage information indicating whether data of the relevant file is stored in the first storage device or not; and
wherein after the data input/output request from the client terminal is switched from the first file server to the third file server, the third file server selects either the first file server or the second file server as a transfer request destination of the target file data of the data input/output request from the client terminal, based on the file data storage information sent from the first file server.

2. The computer system according to claim 1, wherein after the data input/output request from the client terminal is switched from the first file server to the third file server, the third file server sets the first file server as the transfer request destination if the file data storage information about data of the target file of the data input/output request from the client terminal exists; or the third file server sets the second file server as the transfer request destination if the file data storage information about the data of the target file of the data input/output request from the client terminal does not exist.

3. The computer system according to claim 1, wherein the first file server retains directory configuration information which indicates configuration information about a file under a directory accessed by the client terminal and includes the file data storage information of that file; and
wherein after the data input/output request from the client terminal is switched from the first file server to the third file server, the third file server creates a dummy file based on the directory configuration information sent from the first file server and associates the dummy file with the file data storage information and retains them.

4. The computer system according to claim 1, wherein after the data of the file stored in the first storage device is stored in the second storage device of the second file server, the first file server deletes the data of the file stored in the first storage device under a specified condition.

5. The computer system according to claim 1, further comprising a fourth file server for sharing the data of the file, which is stored in the second storage device of the second file server, with the first file server or the third file server,
wherein the fourth file server receives the data input/output request from the client terminal and stores the data of the target file of the data input/output request in a fourth storage device;
wherein the second file server stores the data of the file, which is stored in the fourth storage device and sent from the fourth file server, in the second storage device;
wherein the second file server retains file update information indicating information about a file updated by the first file server or the fourth file server; and
wherein after the data input/output request from the client terminal is switched from the first file server to the third file server, the third file server selects either the first file server or the second file server as the transfer request destination of the data of the target file of the data input/output request from the client terminal based on the file data storage information sent from the first file server and the file update information sent from the second file server.

6. The computer system according to claim 5, wherein the first file server obtains the file update information from the second file server and sends the file update information and the file data storage information to the third file server which is the migration destination.

7. A file server migration method for a computer system comprising:
a first file server for receiving a data input/output request from a client terminal and storing data of a target file of the data input/output request in a first storage device;
a second file server for storing data of a file, which is stored in the first storage device and sent from the first file server, in a second storage device; and
a third file server, which is a migration destination of the first file server, for storing the data of the target file of the data input/output request in a third storage device;
wherein the first file server retains, for each file, file data storage information indicating whether data of the relevant file is stored in the first storage device or not; and
the file server migration method comprises:
a first step of switching the data input/output request from the client terminal from the first file server to the third file server;
a second step executed by the first file server sending the file data storage information to the third file server; and
a third step executed by the third file server selecting either the first file server or the second file server as a transfer request destination of the target file data of the data input/output request from the client terminal, based on the received file data storage information.

8. The file server migration method according to claim 7, wherein in the third step, the third file server sets the first file server as the transfer request destination if the file data storage information about data of the target file of the data input/output request from the client terminal exists; or the third file server sets the second file server as the transfer request destination if the file data storage information about the data of the target file of the data input/output request from the client terminal does not exist.

9. The file server migration method according to claim 7, wherein the first file server retains directory configuration information which indicates configuration information about a file under a directory accessed by the client terminal and includes the file data storage information of that file; and
wherein after the data input/output request from the client terminal is switched from the first file server to the third file server in the first step, the file server migration method comprises a fourth step executed by the third file server creating a dummy file based on the directory configuration information sent from the first file server and associating the dummy file with the file data storage information and retaining them.

10. The file server migration method according to claim 7, comprising a fifth step executed by the first file server deleting the data of the file stored in the first storage device under a specified condition after the data of the file stored in the first storage device is stored in the second storage device of the second file server.

11. The file server migration method according to claim 7, wherein the computer system further includes a fourth file server for sharing the data of the file, which is stored in the second storage device of the second file server, with the first file server or the third file server,
wherein the fourth file server receives the data input/output request from the client terminal and stores the data of the target file of the data input/output request in a fourth storage device;
wherein the second file server stores the data of the file, which is stored in the fourth storage device and sent from the fourth file server, in the second storage device;
wherein the second file server retains file update information indicating information about a file updated by the first file server or the fourth file server;
wherein after the data input/output request from the client terminal is switched from the first file server to the third file server in the first step, the file server migration method comprises a sixth step executed by the third file server selecting either the first file server or the second file server as the transfer request destination of the data of the target file of the data input/output request from the client terminal based on the file data storage information sent from the first file server and the file update information sent from the second file server.

12. The file server migration method according to claim 11, comprising a seventh step executed by the first file server obtaining the file update information from the second file server and sending the file update information and the file data storage information to the third file server which is the migration destination.
